(19) United States
(12) Patent Application Publication
(10) Pub. No.: US 2010/0026626 A1
(43) Pub. Date: Feb. 4, 2010

(54) Efficient keyboards

(76) Inventor: Scott Macfarlane, Manlius, NY (US)

Correspondence Address: Scott Macfarlane, 4677 Watch Hill Road, Manlius, NY, 13104, US

(21) Appl. No.: 12/512,812

(22) Filed: Jul. 30, 2009

Related U.S. Application Data
(60) Provisional application No. 61/084,860, filed on Jul. 30, 2008.
(60) Provisional application No. 61/168,954, filed on Apr. 14, 2009.

(51) Int. Cl. G06F 3/033; G06F 3/02

(52) U.S. Cl. 345/160; 345/157; 345/161; 345/168

(57) ABSTRACT

Ergonomic keyboards incorporating cursor control or scrolling devices where they can be operated with minimal movement of the hands from the home row. The keyboards are peripheral keyboards or are part of a notebook computer or kiosk. Cursor control and scrolling devices are incorporated among the letter and number keys of the keyboard or in the front side of the keyboard housing. Included are keyboards where a graphical pointing device and the mouse buttons associated with it are in different planes, one on the top side of a keyboard housing, the other in the housing's front side. Some ergonomic keyboards incorporate multiple cursor control and scrolling devices. Improved cursor control devices increase the ergonomics of the keyboards. These improvements include improved arrangements and forms of mouse buttons and stick-type cursor control devices that operate as four-way navigation devices.

### PRIORITY CLAIM

The present application claims priority to U.S. Provisional Pat. App. 61/084860 filed on Jul. 30, 2008 and U.S. Provisional Pat. App. 61/168954 filed Apr. 14, 2009, the contents of which are hereby incorporated by reference in their entirety.

### BACKGROUND OF THE INVENTION

The field of the present invention is keyboards for use with computers, word processors, electric typewriters and the like incorporating cursor control and scrolling devices, and improved cursor control and scrolling devices therefor.

Entering text into computing devices often involves not only the alphanumeric keys and other keys of a keyboard, but also a device to control the mouse or graphical cursor (e.g., a stick-type device, such as a pointing stick or trackpoint, mouse, trackball or touchpad), a device (or devices) to control the text cursor (e.g., navigation keys, a four-way controller, a mouse, a touchpad, a trackball, a trackpoint), and a scrolling device (e.g., a scroll wheel, touchpad, scroll strip, scroll ball). To operate these non-keyboard input devices typically requires that the user move his or her hand from their home row typing positions. Most keyboards incorporate navigation keys, but these are located off to the side of the main part of the keyboard to the right alphanumeric keys, or sometimes to the left. Mice are separate, off-keyboard devices. Trackballs are often in separate, off-keyboard devices, and when incorporated into keyboards (and into notebook or laptop computers) are located outside of the alphanumeric keys. Scroll wheels are typically on a mouse or trackball device off-keyboard although some keyboards incorporate scroll wheels; these, like trackballs, are situated outside of the area occupied by the alphanumeric keys. Touchpads are typically built into laptop keyboards centered below the space bar (as are some trackball pointers and scroll wheels), which although requiring less movement of the hands than using a mouse, still require the user to lift his or her hand from the home row typing positions; in addition the housing must extend below (towards the user) the space bar to provide space for the device; newer netbook-style notebook computers often have too little space below the space bar to fit a touchpad mouse cursor control device. An exception is the pointing stick or trackpoint pointer often built into keyboards between the G, H and B keys. These can be used with only a slight shift of a hand from the home row position; however, many users do not like stick-type pointers as they find it hard to use them to accurately or comfortably control the cursor. There is a need, therefore, for keyboards that incorporate non-stick-type cursor control and scrolling devices used in conjunction with a keyboard in locations that allow these devices to be operated without a user having to lift his or her hands from the home typing row, and where they are ergonomic to use. In addition, there is a need to improve the positioning of even those cursor control devices that are positioned where a user can use them without significant hand adjustment, such as the trackpoint positioned in the middle of the keyboard between the G, H and B keys, to reduce the amount of hand movement required when operating them. There is a need for keyboards with scrolling and cursor control devices in positions where those devices can easily be used by touch typists with little or no movement of the typists hands from the home row positions, especially for keyboards incorporating scrolling and text cursor control devices.

Operating the mouse buttons used in conjunction with mouse cursor control devices (e.g., trackballs, touchpads and trackpoints) can require uncomfortable contortion of the user's hand and arm. Utilizing a standard trackpoint or touchpad pointing device can be uncomfortable due to the centering of the mouse buttons below the pointing device. In particular, pressing the right button is awkward for a right-handed user and pressing the left button is awkward for a left-handed user because the user needs to bend his or her thumb back beyond the point of comfort. There is a need for more ergonomic mouse button configurations for trackpoint, trackball, touchpad and other pointing devices that are part of keyboards, built into keyboards, or part of devices, such as laptop computers, which also incorporate a keyboard.

### SUMMARY OF THE INVENTION

When discussing keyboards and their layout, the terms top and bottom and above and below are typically referring to the orientation of an element, such as a key or row, relative to another key or row of the keyboard from a top perspective, where the keyboard is vertically oriented to the user with the bottom row down and the top row up. The bottom row of a keyboard is the row closest to the user in use which on a standard QWERTY keyboard is usually the row of keys containing the space bar, and the top letter row is the row of keys containing the Q and P keys. The number row is considered to be above the top letter row while the top letter row is considered to be below the number key row.

However, when discussing other aspects of a keyboard assembly of which a keyboard is a part, these same orientation descriptors can refer to the orientation or location of an element relative to a three dimensional point of reference. For example, the face of a keyboard housing into which a keyboard is typically incorporated is the top side of the keyboard housing, and bottom side of the keyboard housing is the underside of the keyboard housing which typically rests on a surface like a desk. When one says that the top side is above the bottom side, one is using a different reference frame than when saying the B key is above the space bar. Therefore in the following, to avoid confusion when the frame of reference shifts or whenever a spatial reference is ambiguous, a reference to the X, Y or Z axes will follow a potentially ambiguous term. The plane of the keyboard keys will be treated as being generally in the X-Y plane, with the Y axis substantially parallel to the plane of the keys and orthogonal to the rows of keys (the alphanumeric keyboard can be thought of as being bisected by a line parallel to the Y axis which passes midway between the hands of a touch typists—e.g., between the G and H keys and bisecting the B key of a QWERTY keyboard, or the equivalent on a non-QWERTY keyboard), and the X axis is orthogonal to the Y axis and generally parallel to the rows of keys of the keyboard (at least when they are straight). The Z axis is generally perpendicular to the plane of the keyboard. Some keyboards have curved surfaces and others are at angles to the surface supporting them, and therefore these definitions may be slightly different for different keyboards, but it will be obvious from the use, or non-use of the X, Y or Z notation which frame of reference is being used when in a particular description. The term horizontal is used when referring to moving parallel to the X-axis. The intent of the above is to avoid ambiguity while still using normal terms.

Presented here are keyboards and laptop computers containing keyboards which incorporate one or more scrolling or cursor control devices into the keyboard or laptop in locations where it(they) is(are) generally within easy reach of a user's fingers when the user's hands are in the home touch-typing row positions (for a QWERTY keyboard, these are the left hand fingers on the A, S, D and F keys, and the right hand fingers are on the J, K, L and ; keys [the home row is the row of keys containing these keys which on a QWERTY keyboard is the A row]; thumbs are generally resting on the space bar while a typist's other fingers are on their home row keys). These devices are so positioned so they can be used with little or no movement of the user's hands or arms from their home positions. It is an object of the present invention to make touch typing easier and more ergonomic, and to make scrolling and cursor control devices more convenient for touch-typists and others to use. Scrolling devices, such as scroll wheels, scroll balls and touch sensitive scroll strips, slide text, images or video across the display. Some scrolling devices can only slide text, images or video in a window up or down, while others are capable of panning sideways. Scrolling devices can also often function as clickable mouse buttons. There are two types of cursors a user can control using a cursor control device: the mouse or graphical cursor and the text cursor. Some cursor control devices, such as trackballs, trackpoints and joysticks, touchpads and mice, can be used to control either type of cursor while others, such as navigation keys (up, down, left, right, page up, page down, home and end) and four-way controllers or four-way navigation devices, generally control only the text cursor. Many cursor control devices are also capable of scrolling.

Users of keyboards are generally most comfortable operating scrolling and cursor control devices using either their thumbs or their index fingers, although in some cases the middle finger may also be used. The index fingers and thumbs are near the center of the keyboard when a touch typist is typing. Therefore, in order to ensure easy operation of such scrolling and cursor control devices with an index finger or thumb, such devices should be positioned near the center of the keyboard. To ensure easy operation with an index finger without moving either hand much if at all from their home row positions, such devices are located somewhere between vertical lines parallel to the y-axis through the right edge of the J key and left edge of the F key and within the space occupied by the three letter key rows (the home row and the rows immediately above and below it), and especially adjacent to the home row. Although not quite as easy to use as devices in the area just described, devices will still be more convenient to use than currently positioned device if they are located in the space bar row, the number row or the function key row, and also in an area bounded by vertical (y) lines through the left edge of the D key and right edge of the K key. For convenient operation of the control device using a thumb, one location is in the same central portion of the keyboard and in line with or immediately below the space bar row, immediately below any mouse buttons associated with a mouse cursor control device (or pointing device), or in the front side of the keyboard or keyboard section of the laptop housing (the front side of a keyboard or laptop housing is the side of the housing facing the user when the keyboard is in use). The portion of the keyboard slightly to either side of the keyboard's midpoint will be referred to as the middle or center portion of the keyboard, which is that portion of the keyboard generally within two to two and a half key widths of the midpoint of the keyboard (a vertical line between the G and H keys of a QWERTY keyboard, but more generally a vertical line midway between keys typed with the left hand and those typed with the right hand in a keyboard's equivalent to the QWERTY home row).

For controls device intended to be operated using a middle finger, one location for the control device is within reach of either hand's middle finger such as above or below the D and K keys (e.g. between the E and R keys or I and O keys).

Incorporating a control device such as a scrolling device, pointer (mouse cursor control device) or navigation device (text cursor control device) into a keyboard will often require the altering of at least one of the keys adjacent to the control device to create a space for the control device, since keyboards are generally completely filled with keys. In some cases, the keyboard may be altered to accommodate the control device without changes to the keys themselves such as, for example, by separating the left and right sides of the keyboard by enough distance to fit a scrolling or cursor control device which is mounted in the newly created space, or by locating the device in an otherwise unoccupied spot (such as the front side of the keyboard housing). The underlying circuit board holding the key switch mechanisms and the electrical connections may also have to be modified to accommodate the added control device. In some cases, the control device may be sized to fit in between two keys without requiring the modification of either, such as a thin scroll wheel.

One of the most commonly used devices when typing are navigation keys to move the text cursor up, down, left or right. Unfortunately, in current keyboards, the navigation keys or navigation devices are off to the side of the keyboard, necessitating the movement of at least one hand a significant distance from the touch typing home position. One aspect of the present invention is a keyboard incorporating a navigation device comprising either a four-way navigation device or at least four navigation keys in the center portion of the keyboard within easy reach of a touch typist's hands. In one embodiment, a disk-type or cross-shaped four-way navigation device is incorporated into the keyboard in its center section and adjacent keys are modified and/or shifted to create the necessary room for it. In one embodiment, a disk-type four-way device having a diameter about the same as a key width (about ¾ inch on a standard full-sized keyboard) is incorporated into the keyboard between the 6 and 7 keys, centered in the row, and at least the adjacent two keys (optionally all of the keys) in that row are altered in width and shifted away from the center to create space for the navigation device (if all of the keys in this row are modified and shifted away from the navigation device, the modification to each key can be minimized). In one embodiment, the navigation keys are incorporated into the front side of the housing containing the keyboard; in another embodiment, the navigation keys are directly below (y) the space bar.

Trackpoint or stick-type mouse cursor control devices are small and fit conveniently into the center portion of the keyboard (they are typically located between the G, H and B keys on laptops). One aspect of the present invention is a stick-type device which operates as a four-way navigation device, and keyboards incorporating it. The trackpoint-type four-way navigation device operates such that pushing it towards the right or pressing on its rightmost edge will move the text cursor one character to the right, pushing it up (towards the row above) or pressing down (z) on its uppermost edge will move the text cursor up one line, and so on. This stick-type navigation device is incorporated into keyboards in the central portion of the keyboard for easy access and use when touch typing. In one embodiment, the keyboard incorporates both this stick-type four-way navigation device and a standard stick-type mouse cursor control or pointing device (i.e., a stick-type mouse such as those found on the DELL® Latitutde D630). In another embodiment, the same trackpoint-type device can operate as both a pointer (mouse cursor controller) and a four-way navigation device, depending upon the context and/or user preferences. In one embodiment, switching between mouse and text cursor modes may be accomplished using a dedicated key as a switch. In one embodiment the switch between modes is accompolished by chording with a modifier key (for example, operating the trackpoint-type device while holding down the shift key). Some locations for the stick-type four-way navigation device are adjacent to the G and H keys, such as between the G, H and B keys; the F, V and G keys; the H, N and J keys; the F, T and G keys; the G, Y and H keys; or the H, U and J keys, or adjacent to the J and F keys, such as between the J, M and K keys or the C, F and V keys. Another location is mounted in the front side of a keyboard housing or keyboard section of a laptop housing, with the axis of the trackpoint stick roughly parallel to the Y axis of the keyboard (i.e., pointing out of the laptop or keyboard housing towards the user) and perpendicular to the front side.

One aspect of the present invention is a keyboard incorporating two stick-type cursor control devices, both devices situated in the middle portion of the keyboard within easy reach of a touch typist's index fingers while typing. Good locations for these devices are symmetrical around the midline of the keyboard adjacent to the G and H keys, or to the F and J keys, such as with the first stick-type cursor control device positioned between the F, T and G keys and the second one positioned between the H, U and J keys, with the first stick-type cursor control device positioned between the F, G and V keys and the second positioned between the H, J and N keys, or with the first between the V, G and B keys and the second between the B, H and N keys. In another embodiment, the first stick-type device is positioned between the Y, G and H keys and the second is positioned between the G, H and B keys. In some versions there is a third stick-type cursor control device positioned between the other two stick-type cursor control devices, such as between G, H and B keys or the G, Y and H keys. In another embodiment, the first stick-type cursor control device is positioned between the F and G keys and the second between the H and J keys, each device more or less in line with the center of the adjacent keys. Each of these stick-type cursor control devices can operate as a pointing device or as a four-way navigation device, or as both depending upon the context or user preferences. In one embodiment, at least one of these stick-type cursor control devices is replaced with a mini-trackball device.

Another aspect of the current invention is a keyboard incorporating a scrolling device situated directly among the keys of the keyboard, such as in the center portion of the keyboard where it can easily be operated using an index finger while touch typing. The scrolling device can be a touch-sensitive scroll strip, scroll ball, scroll wheel, or any type of scrolling device having a form factor conducive to being incorporate in among the keys of an alphanumeric keyboard. The scroll wheel can be incorporated into the keyboard can have its axis of rotation parallel to the rows of keys or parallel to the Y axis. In one embodiment, the scroll wheel is positioned between two keys of the same row with its axis aligned with the centerline of that row. In one embodiment, the scrolling device is sized to fit wholly within the Y-dimension of the row so that no changes are required to the keys (or their key caps) in adjacent rows above and below the row in which the scroll wheel is located. In one embodiment, the scroll wheel is larger in diameter than the distance between two rows separated by a single row, and changes are required to the keys of at least one of the adjacent rows. Unless the right and left hand halves of the keyboard have been split and the scrolling device is between the sections, one or more keys in the same row are adjusted in width (x) to provide space for the scrolling device. In one embodiment, the scrolling device is positioned between the two halves of the keyboard (i.e., those keys operated with the left hand and those operated with the right), such as between the G and H keys, the B and N keys, the T and Y keys, or the 6 and 7 keys. In one embodiment, the scrolling device is situated elsewhere among the keys of the keyboard, such as between the F and G keys or between the H and J keys for easy use with one hand or the other. In one embodiment, the scroll wheel has a width (parallel to the axis) similar to that of scroll wheels found on many computer mice—about 0.5 cm or 0.25 inch. In one embodiment, the scroll wheel's width is less, such as ⅛ or 1/16 or even thinner, so that it can fit more easily between two adjacent keys in the same row, and less adjustment to the width of the keys in that row, and to their keycaps, is necessary. In one embodiment, there are multiple scrolling devices situated in the middle portion of the keyboard—examples are: with one between the R and T keys and one between the Y and U keys; with one between the C and V keys (or the V and B keys) and one between the N and M keys; with one between the 4 and 5 keys and one between the 7 and 8 keys; and with one between the F and G keys and one between the H and J keys. In one embodiment, the scroll wheel is mounted on a moveable powered jack or mount which raises the scroll wheel when the computer is powered up (or when the laptop is opened and powered up) and lowers it when the computer is powered off (or when the laptop is closed).

Another aspect of the invention are keyboards incorporating multiple scrolling and cursor control devices of different types. Embodiments include keyboards combining a scroll wheel situated centered in the A row and between the G and H keys with a stick-type cursor control device situated between the F, G and V keys (or the T, F and G keys) or with a stick-type cursor control device situated between the H, N and J keys (or the H, U and J keys), or with two stick-type cursor control devices, with one in each of the aforementioned positions. Another example is a four-way navigation device situated in between the T, Y, G and H keys or between the 6 and 7 keys combined with a trackpoint-type device situated between the F, V, and G, the G, H and B, or the H, J and N keys, or in more than one of those locations.

Another aspect of the invention are improved cursor control devices and keyboards incorporating them comprising three or four buttons mouse buttons aligned below the space bar and/or a pointing device such as a touchpad or trackball which can all be configured as left or right click buttons. In an embodiment having four buttons, the right two buttons are configured as right and left buttons to be operated using the left hand and the left two buttons are configured as right and left buttons to be operated using the right hand. In one embodiment there are three buttons, with the middle button approximately twice the width of the left and right buttons, and either one of the right and left buttons are configured along with the middle button as either a right- or left-click button, and the remaining button is configured as the other click button (if the two are configured as right-click buttons, the remaining is configured as the left-click button).

One aspect of the present invention is a keyboard incorporating a scrolling, cursor control or navigation device among the keys of the four number and letter rows in between the sections typed with each hand (in a QWERTY keyboard the dividing line of the portions typed with the left and right hands is for most typists between the 6 and 7, T and Y, G and H, and B and N keys); within one key to either side of the dividing line between those two sections (between the left edge of the 6, T, G and B keys and the right edge of the 7, Y, H and N keys respectively); within two keys to either side of the dividing line between those two sections (between the left edge of the 5, R, F and V keys and the right edge of the 8, U, J and M keys respectively); or within three keys to either side of the dividing line between those two sections (between the left edge of the 4, E, D and C keys and the right edge of the 9, I, K and , keys respectively), or in the space bar row immediately below (y) the B key.

One aspect of the present invention is a keyboard incorporating a scrolling, cursor control or navigation device in a location that in a standard keyboard would be occupied by a letter or number key or part of it. One aspect of the present invention is a keyboard in which one or more letter, number, space or punctuation keys and/or key caps are modified to make room for a scrolling or navigation device.

One aspect of the present invention is a keyboard assembly (such as a peripheral keyboard for a desktop computer, a keyboard built into a kiosk housing, or the keyboard section of a laptop computer) incorporating a key, scrolling device or cursor control device in the front side of the housing for the keyboard (the front side of keyboard housings generally face the user when the keyboard is in use) oriented orthogonal to its normal orientation when incorporated into a keyboard or into the top side of a housing incorporating a keyboard also in its top side. In embodiments where the device built into the front side is a mouse cursor control device, the built-in device can be aligned in the y-direction with the mouse cursor control device. In some embodiments, the device is aligned with the center of the keyboard so that the device is can be accessed easily by either of the user's hands when touch typing. The key can be a navigation key, a functional key such as Backspace delete or Delete, a Ctrl (Control) key, a mouse key or button, or some other key found on keyboards. The cursor control device can be a trackpoint, trackball, touchpad, four-way navigation device, four navigation keys, mouse buttons or a joy stick. The scrolling device can be a scroll wheel, scroll ball or touch sensitive scroll strip. In one embodiment, a scroll wheel is mounted in the front side of a keyboard housing or laptop keyboard section housing with its axis parallel to the Z axis and the scroll wheel protruding through the front side of the housing.

One aspect of the present invention is a thin-profile scroll wheel measuring less than ⅛ inch, or less than 1/16 inch or less than about 1/32 inch such that it can fit between adjacent keys in a row of keyboard keys without requiring much or any change in the dimensions of the adjacent keys and/or their keycaps. One aspect of the invention is a keyboard incorporating a scroll wheel situated between two adjacent letter or number keys in the same row of keys with its axis aligned with the central axis/horizontal midline of the row.

### BRIEF DESCRIPTION OF THE DRAWINGS

FIG. 1A is a top plan view of a portion of a keyboard incorporating a stick-type cursor control device.

FIG. 1B is perspective view of one embodiment of a stick-type four-way navigation device.

FIG. 1C is a partial perspective view of a keyboard incorporating a square-capped stick-type four-way navigation device.

FIG. 1D is a top plan view of a keyboard incorporating a four-way navigation device between two number keys.

FIG. 2A is a top plan view of a keyboard incorporating two stick-type cursor control devices adjacent to the home row and four mouse buttons.

FIG. 2B is a partial top plan view of a keyboard incorporating three stick-type cursor control devices.

FIG. 2C is a top plan view of a split keyboard incorporating two stick-type cursor control devices and four mouse buttons.

FIG. 2D is a left perspective view of a notebook computer incorporating two stick-type cursor control devices adjacent to the home row and four mouse buttons.

FIG. 3 is a top plan view of a keyboard incorporating a scroll wheel between the G and H keys and four navigation keys below the space bar.

FIG. 3A is a partial top plan view closeup of the keys adjacent to the scroll wheel in FIG. 3.

FIG. 3B is a perspective view of a scroll wheel assembly.

FIG. 3C is a perspective view of the printed circuit board supporting the keys of the keyboard showing how the scroll wheel assembly in FIG. 3B is mounted into a keyboard.

FIG. 3D is a top plan view of a keyboard incorporating two scroll wheels among the keys of the keyboard.

FIG. 3E is a top plan view of a keyboard in which the keys typed with each hand are separated by a gap in which is situated a scroll wheel and a stick-type cursor control device.

FIG. 3F is a partial top perspective view of a segment of a keyboard incorporating a ball-type cursor control device between the G, H and B keys.

FIG. 4A is a top plan view of a touchpad assembly which incorporates three mouse buttons, the middle of which is about twice the width of the other two.

FIG. 4B is a top plan view of a touchpad assembly which incorporates four mouse buttons.

FIG. 5A is a perspective view of a keyboard assembly incorporating a scroll wheel having a vertical axis of rotation in the front side of its housing.

FIG. 5B is a perspective view of a notebook computer incorporating a scroll wheel having a vertical axis of rotation in the front side of its keyboard section's housing.

FIG. 5C is a partial perspective view of a scroll wheel assembly and the inner front side of the housing in which it is mounted.

FIG. 5D is a partial perspective view of a keyboard incorporating a scroll wheel having a horizontal axis of rotation and protruding from both the front and top sides of its housing.

FIG. 5E is a perspective view of a peripheral keyboard incorporating a touch-sensitive scroll strip in the front side of its housing.

FIB. 6A is a perspective view of a keyboard incorporating a trackball and four mouse keys in the front side of its housing.

FIG. 6B is a perspective view of a keyboard incorporating a stick-type cursor control device in the front side of its housing and two associated mouse keys below the space bar in its top side.

FIG. 6C is a perspective view of a keyboard incorporating a four-way navigation device in the front side of its housing.

FIG. 6D is a perspective view of a keyboard incorporating four navigation keys in the front side of its housing, a touchpad in its top side, and mouse buttons associated with the touchpad in the housing's front side.

FIB. 7A is a perspective view of a laptop computer incorporating a trackball and four mouse keys in the front side of the keyboard section of its housing.

FIG. 7B is a perspective view of a laptop computer incorporating a stick-type cursor control device in the front side of the keyboard section of its housing and two associated mouse keys below the space bar in its top side.

FIG. 7C is a perspective view of a keyboard incorporating four navigation keys in the front side of the keyboard section of its housing, a touchpad in its top side, and mouse buttons associated with the touchpad in the housing's front side.

FIG. 7D is a perspective view of a laptop computer incorporating a touch-sensitive scrolling strip in the front side of the keyboard section of its housing, a stick-type cursor control device among the keys of the keyboard in the housing's top side, and three mouse buttons aligned below the space bar, the middle of which is wider than the other two.

FIG. 7E is a perspective view of a laptop computer incorporating a stick-type cursor control device among the keys of the keyboard and two associated mouse buttons incorporated into the front side of the keyboard section of the computer's housing.

FIG. 8A is a perspective view of a partial cutaway of the inside of the front side of a housing for a keyboard.

FIG. 8B is a perspective view of an assembly incorporating a stick-type cursor control device designed for incorporation into the housing shown in FIG. 8A.

FIG. 8C is a perspective view of an assembly incorporating a touch-sensitive scrolling device designed for incorporation into the housing shown in FIG. 8A.

### DETAILED DESCRIPTION OF THE DRAWINGS

One aspect of the present invention is a stick-type navigation device, and keyboards incorporating them, which functions like a four-way navigation device or controller and the up, down, left and right navigation keys to move the text cursor up, down, left and right on the display.

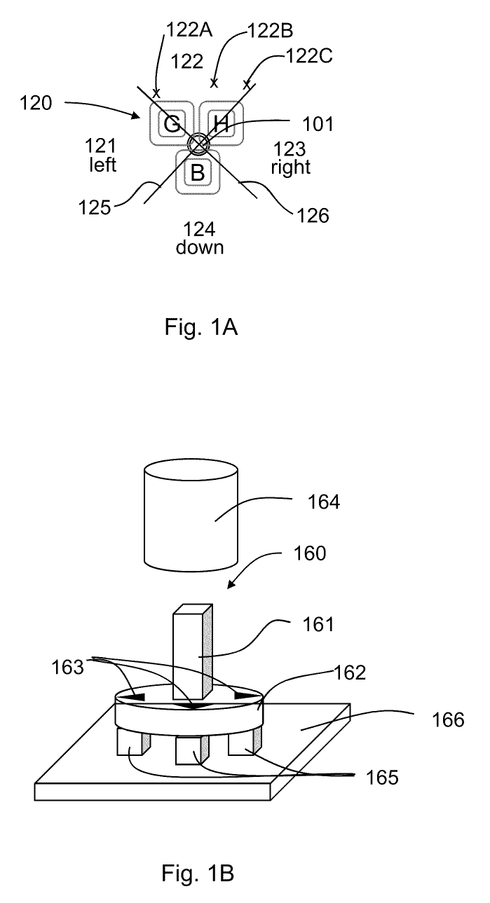

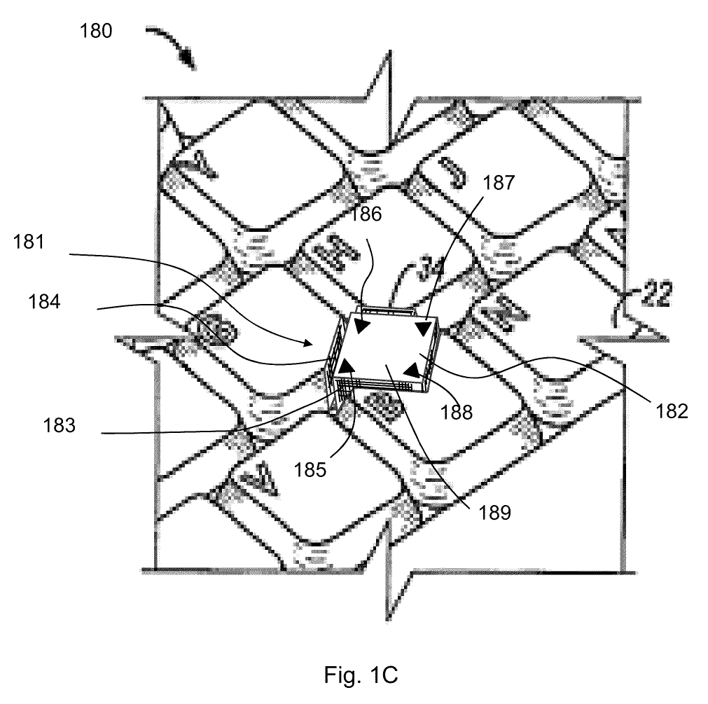

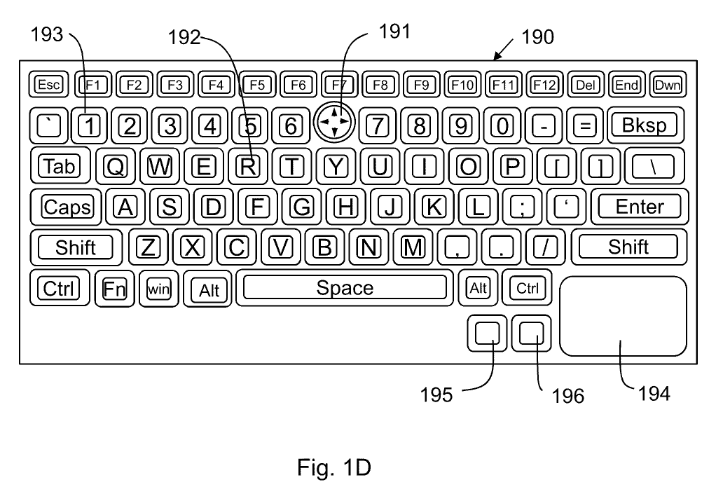

In one embodiment, the stick-type navigation device operates only as a navigation device and comprises a device with four separate switches, one for each direction, the switches in the same relation to each other as the four cardinal points of the compass are to each other. FIG. 1B shows a stick-type navigation device 160 in perspective view. Stick-type navigation device 160 comprises a shaft 161 mounted solidly the center of base 162. Base 162 is supported by four key switches 165 (only three shown) which are in turn supported by substrate 166; alternately base 162 may be supported by a spring directly opposite the shaft 161 which allows the base 162 to tilt. The arrows 163 are above the switches and for illustration purposes only. Trackpoint cap 164 fits over the shaft 161, having an orifice shaped to accept the square shaft 161 (not shown). To operate, the user pushes the shaft 161 until one of the switches 165 engages. Each switch 165 is associated with one of the four directions of possible text cursor movement and are arranged in clockwise order, left, up, right and down. Engaging a switch is equivalent to engaging a navigation key; it moves the text cursor in the associated direction. The device 160 is designed to be able to fit in the same space occupied by a standard trackpoint pointer device. Device 160 can be seen as equivalent in construction to a disk-shaped four-way controller with a shaft affixed to its center. Alternate constructions of device 160 are possible including one comprising a shaft mounted to a gimbal, spring or flexible element which is mounted to the substrate, four switches arranged at the cardinal points of the compass on the inside of an element centered around the shaft and enclosing an inner space with a cross-section matching that of the shaft in shape and proportion (if the shaft is square, the inner opening confined by this element is square; if the shaft is cylindrical, the element encloses a circular space) wherein the switches are oriented towards the shaft (i.e., the direction in which they are pressed to engage is orthogonal to the shaft) so that pushing the shaft towards a switch will engage the switch.

In one embodiment, the stick-type navigation device is a stick-type mouse cursor control device such as IBM's trackpoint capable of detecting movement of the stick in any direction and translating that into movement of a mouse cursor in any direction on the screen. To operate as a four-way navigation device, the driver software for the stick device translates continuous directional movement of the stick into discrete left, right, up and down movements of a text cursor. FIG. 1A, shows a plan top view of a segment (three keys—G, H and B) of a QWERTY alphanumeric keyboard having a trackpoint-type device 101 situated between the G, H and B keys that is constructed to be capable of detecting movement of the stick in any direction and which functions as a four-way navigation device.

To function as a four-way controller, the operating software identifies four quadrants 121-124 (any number of directional sectors can be defined) which are defined by orthogonal diagonals 125 and 126 intersecting at the center of device 101 and at 45 degree angles to the X and Y axes, left 121, up 122, right 123 and down 124 quadrants. Any force on the trackpoint-type device 101 that registers initially as a movement towards a point within a particular quadrant is translated or transduced by the driver software for the device 101 into movement of the text cursor in one of four directions—left, up, right or down. For example, a force towards any point within the up quadrant 122, such as towards points 122A, 122B or 122C, are translated into an up movement of the text cursor; force towards points in the left 121, right 123 and down 124 quadrants are transduced respectively into left, right and down movements of the text cursor. The trackpoint-type navigation device can operate like a navigation key such that if it is pressed and released within a predetermined time the text cursor will only move one increment (e.g., one character or one line), and if it is pressed and held for more that predetermined time period, the text cursor will repeat the movement until released. Feedback can be provided to the user, such as an audible click which marks each incremental movement of the text cursor. Trackpoint-type devices capable of detecting movement in any direction can function as either a mouse cursor controller or a four-way navigation device. The G, B and H keys could be any other adjacent keys of any keyboard in any language.

A stick-type device capable of operating as both a four-way navigation device and a mouse cursor controller can be said to have two modes of operation: navigation key mode wherein it operates as a four-way navigation device; and trackpoint or mouse mode wherein it operates as a standard trackpoint mouse cursor control device. Navigation key mode and mouse mode are implemented in the driver software for the device to enable it to translate actions on the trackpoint-type device into navigation key type movements of the text cursor or mouse cursor movements.

The stick-type navigation device can be shaped in a way that makes it easier to use as a four-way navigation device. FIG. 1C, a perspective view of a segment 180 of a QWERTY keyboard which comprises keys 22, including the G, H and B keys, and a four-way navigation device 181 approximately centered between the G, B and H keys. Device 181 is has a cap 182 with a square cross-section. Cap 182 fits over a shaft (not shown) such as shaft 161 in FIG. 1B in the same way that cap 164 does. Device 181 can be a device such as device 160 or another of the stick-type navigation devices described herein. Cap 182 can have a square cross-section over its entire length (be an extruded square), or its base section 183 can be a different shape from its top. In one embodiment, device 181 is a disk-type four-way navigation device wherein the disk is square. One of the cap's 182 diagonals is parallel to and midway between the A and Z rows. Device 181 can be a dedicated four-way navigation device, or a device which operates in both navigation key and trackpoint modes. In 4 way navigation device mode, pressing left corner 185, top corner 186, right corner 187 or bottom corner 188 is equivalent to pressing a left, up, right or down navigation key respectively. The cap 182 can be other shapes with four corners or arms.

Stick-type navigation devices can be located in many positions on the keyboard. In one embodiment, it is located where trackpoint mouse cursor control devices are typically located, between the G, H and B keys. In another embodiment, it is located between the G, H and Y keys. In these two positions, the 4-way navigation device 101 is equally easy to reach with the index finger of either hand when the user's hands are in the home position for touch-typing, but it is unlikely to be accidentally struck during typing since it is between keys generally typed with different hands. In any position, adjacent keys, their key caps and associated key switches may need to be modified to make room for the navigation device. The stick-type navigation device can be in the middle portion of the keyboard, in or adjacent to the home row of keys, and it can also usefully be in any position among the letter and number rows of keys in the center section of the keyboard.

In an embodiment comprising a stick-type navigation device that can also be operated in mouse mode, there must be a way to switch from one mode to another. Many trackpoint devices on the market allow users to optionally configure the action of pressing down on the trackpoint to function as a left mouse button click, and in the present invention, users can have the option of configuring a vertical (z) push down as the way to switch the trackpoint-type device into navigation key mode. Another way to switch modes can be by holding down the trackpoint-type device or holding down a modifier key such as the shift key, Ctrl, Alt or Fn key (modifier keys are good because they cause an action only when pressed in combination with another key) while operating the trackpoint-type device. In one embodiment, if the user is pressing the appropriate modifier key while operating the stick-type navigation device, device will operate in navigation key mode; otherwise the device will operate as a standard trackpoint mouse cursor control device. In an alternate embodiment, navigation key mode can be the default mode of the device and operating in trackpoint mode can require pressing down a modifier key or on the device while it is being operated. Additional modes of operation are possible. In one embodiment, holding down the shift key while using the device can cause it to operate in navigation key mode, and pressing the Ctrl key while operating the device can switch it into a third operating mode. In the third operating mode, the four possible commands are page up, page down, home and end (for example, pushing up (y) on the trackpoint device is equivalent to pressing the page up key, pushing the device towards the B key is equivalent to pressing the page down key, pushing the device right is equivalent to pressing the end key, and pushing the device left is equivalent to pressing the home key. Holding the Alt key down while operating the device could switch it into a fourth operating mode with four more functions such as Ctrl-Right, Ctrl-Left, and go to the top or bottom of the current page.

In addition to being able to move a mouse cursor in any direction, it is often desirable to move it in an perfectly horizontal or perfectly vertical direction. Unfortunately, it is often difficult to move a mouse cursor in a straight line, particularly horizontal and vertical lines. This is especially true of stick-type mouse cursor control devices. In one embodiment of a trackpoint-type device capable of operating in trackpoint mode, pressing down vertically on the trackpoint with sufficient force or holding down a modifier key switches the trackpoint device into horizontal-vertical operating mode where all lateral forces will cause the mouse cursor to move only in one of four directions, horizontal right, horizontal left, vertical up and vertical down, starting from the current mouse cursor's current position. Referring to FIG. 1A, for example, forces towards a point in quadrant 121, for example, will be translated into horizontal leftward mouse cursor movements on the display, while forces towards quadrant 122 will be translated into vertical upwards mouse cursor movements on the display. Horizontal-vertical mode and navigation key mode can be implemented on any mouse cursor control device, including trackpoints, trackballs, touchpads and mice.

The method of operating a stick-type pointer as a four-way navigation device is: define set of vectors of mouse cursor movements that will be transduced into each type of text cursor movement; obtain initial directional vector from the operation of the pointer; translate the directional vector into a cursor movement.

It should be pointed out that although the embodiments described above are for stick-type navigation devices having a form factor similar to the trackpoint and stick-type mouse cursor controllers (pointers) found on many laptop computers, the devices can have other form factors. The four-way navigation device does not have to be a stick-type device. It can be a disk four way controller or another type of four-way navigation device, or it can be another type of mouse cursor controller, such as a trackball, provided it is small enough to fit roughly in the space occupied by a typical trackpoint mouse pointer.

Navigation devices other than stick-type navigation devices can be incorporated into a keyboard among the alphanumeric keys in the center of the keyboard. FIG. 1D is a plan view of the keys of a keyboard 190 comprising keys 192 and a disk four-way navigation device 191 (the four-way navigation device can have other forms, such as a cross-shaped device or four small buttons). In one embodiment, four way navigation device 191 has a ring that functions as a four-way navigation device encircling a center button for that functions as the Enter key; such a four way navigation device is similar to the four-way controller interface devices found on many digital cameras. Device 191 is situated above the Y key in the number row 193 between the 6 and 7 keys. Instead of reducing the width of just the 6 and 7 keys to make room for the navigation device 191, all keys in the number row 193 are reduced slightly in width and shifted away from the navigation disk 191 to create a space approximately ¾ to 1 inch wide. Because on many keyboards there is a gap between the row of number keys and the function key row, as there is in keyboard 190, there is more than the ¾ inches that typically separates one row from a row one row away. Navigation device 191 is easily accessible to either hand. The reduction in the width of each key in the number row is minimal (1 inch/14 keys= 1/14^{th} inch or about 10% for the number keys, leaving the keys sufficiently wide for easy operation. For those people not able to touch type numbers and punctuation, the slight shift in the position of the keys will create no problems; for touch typists some learning of the new positions of the keys will be necessary. The maximum shift of any keys is about one-half inch, and the shift gets smaller the further from the navigation device 191 the key is located in the number row. In one embodiment, a trackball mouse is substituted for the disk navigation device 191 in keyboard 190, and mouse buttons can be added to keyboard 190 centered under the trackball immediately below the space bar.

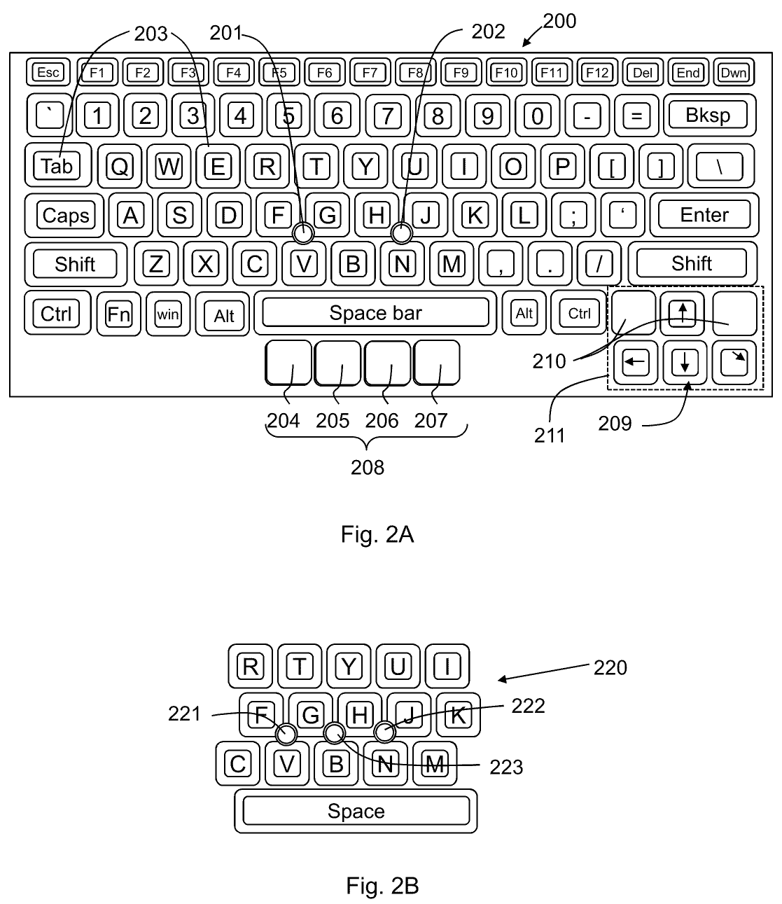

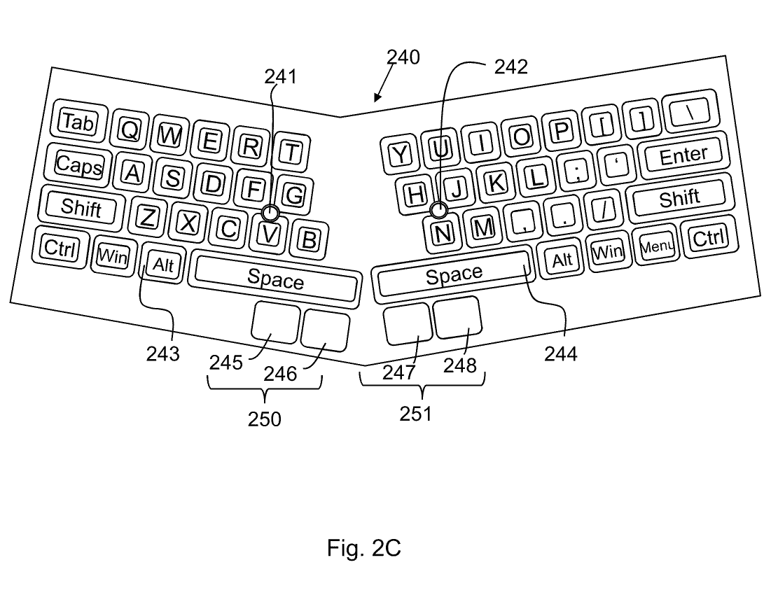

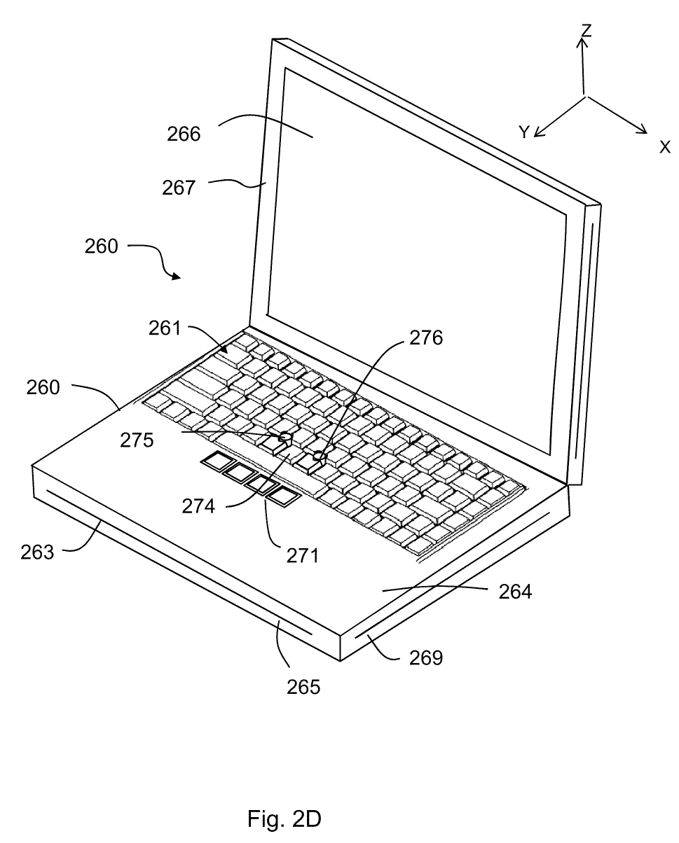

By locating a four-way navigation device 191 among the keys of the keyboard, the space in the lower right hand corner of a keyboard with a typical laptop computer layout often occupied by the navigation keys can be used for a touchpad or other cursor control device. Referring to FIG. 2A, this space 211 is encircled by a dotted line. Within space 211 there are four navigation keys 209 with right, left, up and down arrows as labels arranged with the left, down and right arrow keys aligned horizontally in that order with the fourth up key directly above the middle of the three keys (the down arrow key), plus space 210 for two keys, one directly above the left arrow key and one directly above the right arrow keys; in some keyboards these spaces 210 is unused while in others various keys are situated there. The general key layout for keyboard 190 is the same as that for keyboard 200, except that the space 211 occupied on keyboard 200 by the navigation keys 209 and space for two keys 210 has been replaced on keyboard 190 by a touchpad cursor control device 194. Keyboard 190 also comprises two mouse buttons, left 195 and right 196, aligned horizontally and adjacent to the lower left side of the touch pad 194. In one embodiment, touchpad 194 is replaced by a trackball. As described elsewhere herein, the mouse buttons for the touchpad 194 (or the trackball) can also be incorporated into the front side of the housing into which the keyboard 190 is incorporated, positioned so that the user presses the buttons towards the front side of the housing to operate them. The layout of keyboard 190 is conducive to operation of the touchpad 194 with the right hand. In one embodiment, the Ctrl, Fn and Win keys in the lower left-hand corner of keyboard 190 and the touchpad 194 and mouse buttons 195 and 196 are removed, the Fn and Win keys are relocated to next to the Ctrl key to the right of the space bar, and a touchpad is put in the lower left-hand corner of keyboard 190, partially occupying the space formerly occupied by the left Ctrl, Fn and Win keys, with two mouse buttons aligned horizontally off the touchpad's lower right-hand corner under the left Alt key and Space bar.

To operate a typical trackpoint-type mouse, or a stick-type navigation device, located in the typical location between the G, B and H keys requires movement of one hand away from its home row typing position. To eliminate the need to move a hand, the device can be relocated to a location within reach of one finger without moving the other three fingers of the same hand off their home keys. Suitable locations are adjacent to the F and J keys, either above or below the home row, such as between the F, V and G keys, F, T and G keys, H, U and J keys, or H, N and J keys, where the device can be reached easily with the index finger of the nearest hand while the other fingers of that hand remain on their home row keys. While devices so located are easier and more ergonomic to use, locating such devices other than centered between the G and H keys means that the device is no longer equally accessible to both hands. In order that a device is equally easy to use with either hand, a second device can be added to the keyboard, preferably symmetrically across the keyboard's midpoint. Others have described or built keyboards with two trackpoints. IBM built a keyboard with two trackpoints where one trackpoint is between the C and V keys and the space bar, and the other trackpoint is between the N and M keys and the space bar. U.S. Pat. No. 6,184,867 describes using two trackpoints in those same positions for cursor control in 3-D on the screen. These locations are not convenient for use by touch typists because it requires some contortion of the hands to operate a trackpoint with the index finger while keeping the other three fingers on the home row of keys. Locations adjacent to the F, G, H and J keys are within much easier reach of the index finger while the hands are in the home row positions.

FIG. 2 is a plan view from above of a QWERTY keyboard 200 comprising keys 203, a first device 201 situated between the F, V and G keys, a second device 202 situated between the H, N and J keys, and four roughly equally sized mouse buttons 208, left 204, left middle 205, right middle 206, and right 207, aligned horizontally in that order left to right below (y) the space bar and centered as a group below (y) the B key. Devices 201 and 202 can be stick-type mouse pointers (e.g., trackpoints), stick-type four-way navigation devices, or some other device of similar size such as a mini-trackball or mini-scroll ball. Devices 201 and 202 can be the same or different types of devices. Device 201 or 202 can be a mouse pointer capable of operating also in navigation mode. First device 201 is intended to be used with the index finger of the left hand while second device 202 is intended to be operated using the index finger of the right hand. Several alternative symmetrical locations for first device 201 and second device 202 in alternate embodiments are between the F, G and T keys and the H, J and U keys, between the V, G and B keys and the B, H and N keys respectively, and between the C, F and V keys and N, J and M keys respectively; other alternative locations will be obvious. Devices 201 and 202 in these locations will interfere minimally, if at all, with typing, and in the given positions, they are easy and comfortable to operate using the index finger of the nearest hand without moving the other three fingers from their home row positions, or over- or hyperextending the index finger while stretching it sideways, a movement that causes strain in the hand and forearm. The top of the devices 201 and 202 can be level with, slightly above, or slightly below the top (z) of the adjacent keys to make them easier to use or to make them less likely to interfere with typing.

While mouse buttons 208 can be configured to operate in any way, one ergonomic configuration is for the two left buttons 204 and 205 to be configured for use with the right thumb while the right index finger operates right device 202 (such as left button 204 as a left mouse button and left-center button 205 as a right mouse button), and the two right buttons 206 and 207 to be configured for use in conjunction with the left device 201. Configuring these buttons in this way makes it more ergonomic to operate the buttons in conjunction with one of the devices because the thumb is in an extended position rather than having to be bent inwards. The mouse buttons 208 can be of various sizes, such as ¾″ by ¾″ or 1 inch wide by ¾ inch high.

A third device can be added to the center of the keyboard. FIG. 2B is a plan view of a segment 220 of a QWERTY keyboard comprising a first device 221 situated between the F, V and G keys, a second device 222 incorporated into the keyboard between the H, N and J keys, and a third device 223 incorporated between the G, B and H keys. Devices 221, 222 and 223 can each be a stick-type navigation device, a trackpoint mouse, a mini-scroll ball or a mini-trackball, or a stick-type device capable of operating in both mouse mode and navigation mode. In one embodiment, device 223 is controls the mouse cursor and devices 221 and 222 are four-way navigation devices. In one embodiment, device 223 is a trackpoint-type four-way navigation device, and devices 221 and 222 are standard trackpoint mouse cursor control devices.

It is appropriate for there to be more than one stick-type device incorporated into a split keyboard so that one trackpoint device is within easy reach of each hand. FIG. 2C is a plan view of a portion of a split keyboard 240 (the number keys are not shown) which comprises a left keyboard segment 243 and a right keyboard segment 244 at angles to each other, a first stick-type device 241 situated between the F, G and V keys, a second stick-type device 242 situated between the H, J and N keys, a first pair of mouse buttons 250 situated beneath the space bar of the left keyboard segment 243, and a second pair of mouse buttons 251 situated beneath the space bar of the right keyboard segment 244. First pair 250 comprises a left 245 and a right 246 button aligned parallel to the space bar of the left segment 243, with the left button 245 aligned under the first device 241 (a line perpendicular to the rows of the left segment 243 will intersect both). Second pair 251 comprises a left 247 and a right 248 button aligned parallel to the space bar of the right keyboard segment 244, with the right button 248 aligned with second device 242 (a line perpendicular to the rows of the left segment 243 will intersect both). The positioning of the left buttons 250 are for ergonomic left-handed operation of them in conjunction with the first device 241 while positioning of the right buttons 251 are for ergonomic right-handed operation in conjunction with second device 242. Buttons 245, 246, 247 and 248 can each be configured as left and right mouse buttons according to user preferences. A further advantage of having two pairs of mouse buttons, is that users can easily operate one stick-type device with one hand and operate the mouse buttons associated with (or closest to) the other stick-type device with the other hand. The buttons can be of various sizes, with a width (x) of 1 to 1.5 inches and a y-dimension of ⅔s to 1.25 inches being one appropriate size range.

The devices can be alternatively located in the locations described above for a standard, non-split keyboard. One other alternative location is for the left first device 241 to be located between the lower right corner of the G key and center top of the B key and the right second device 242 to be located at the lower left corner of the H key with the three keys modified the same way they typically are when a trackpoint is situated between the G, H and B keys of a standard keyboard. By locating the stick-type devices such, each is in exactly the same location for each hand from the user's perspective as it would be on a standard keyboard with a trackpoint device situate between the G, H and B keys, thereby reducing the learning curve when going between split and regular keyboards.

The keys of keyboards 200 are QWERTY English-language keyboards laid out in a way that is common to laptop computer-type keyboards, but the two devices 201 and 202 can be incorporated into the same or similar positions in any type of keyboard, in any language (including peripheral keyboards for desktop computers, netbooks and notebook computers).

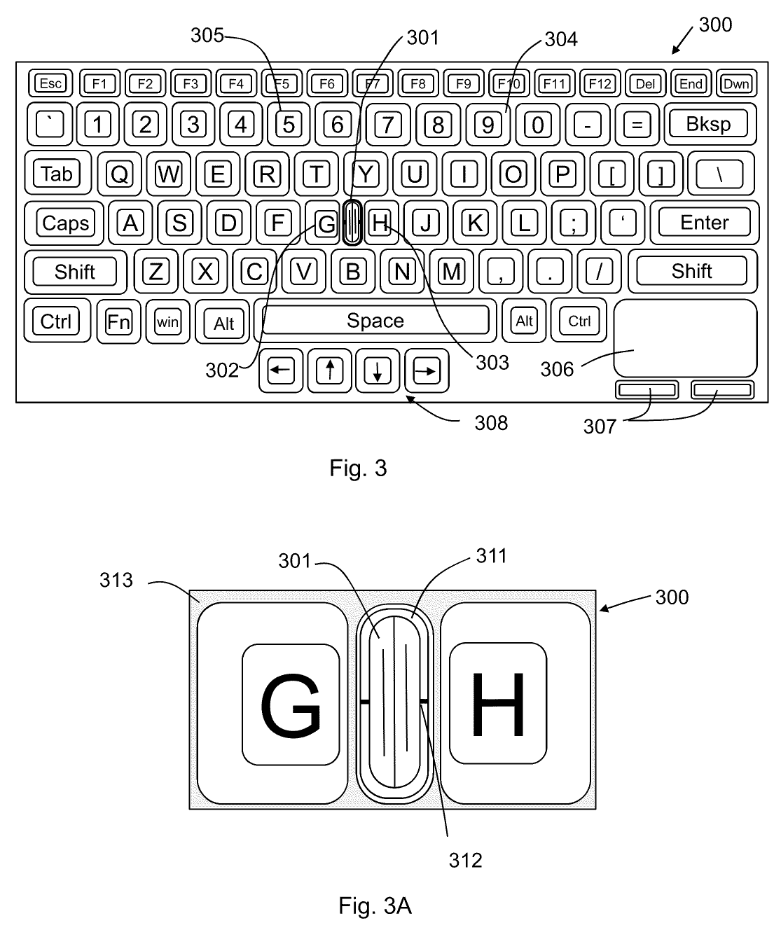

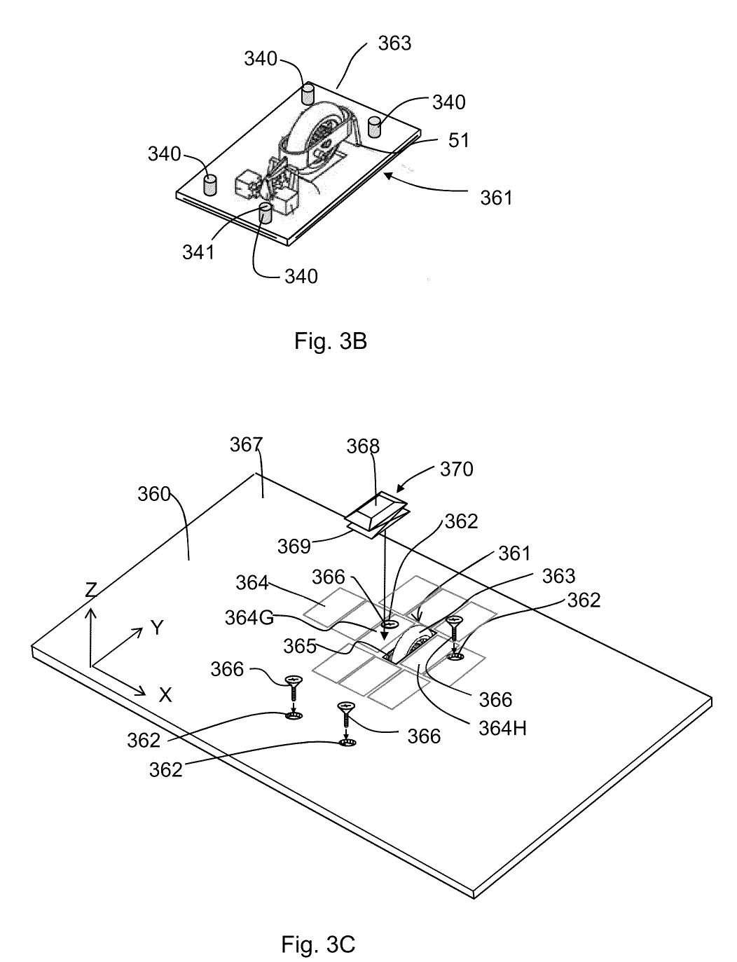

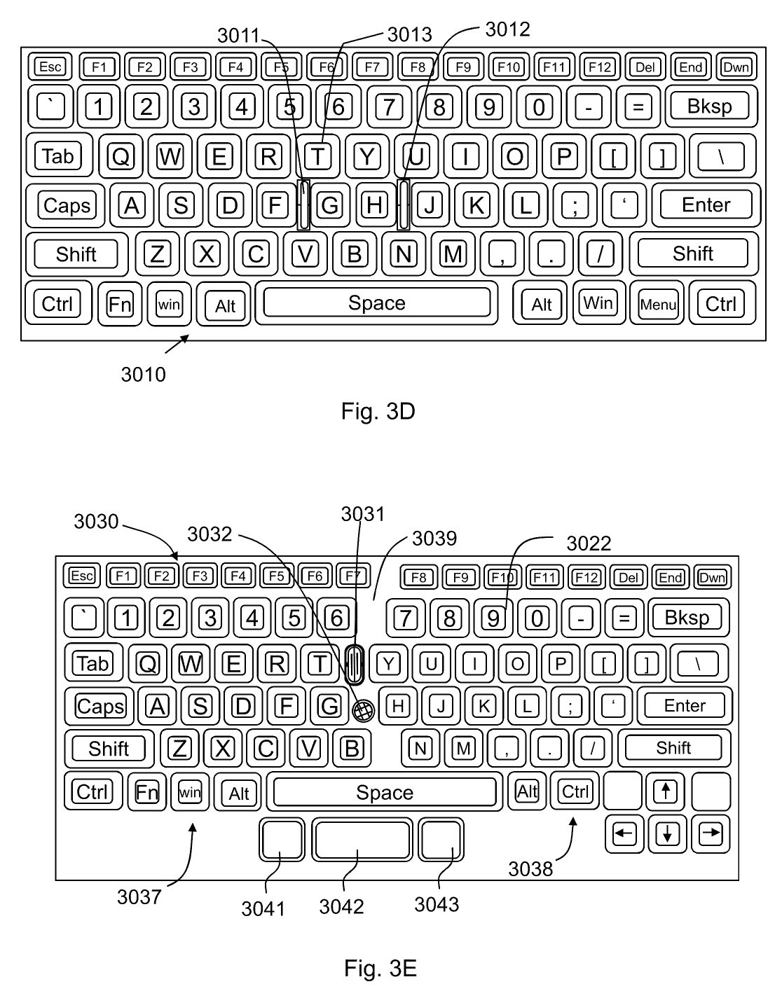

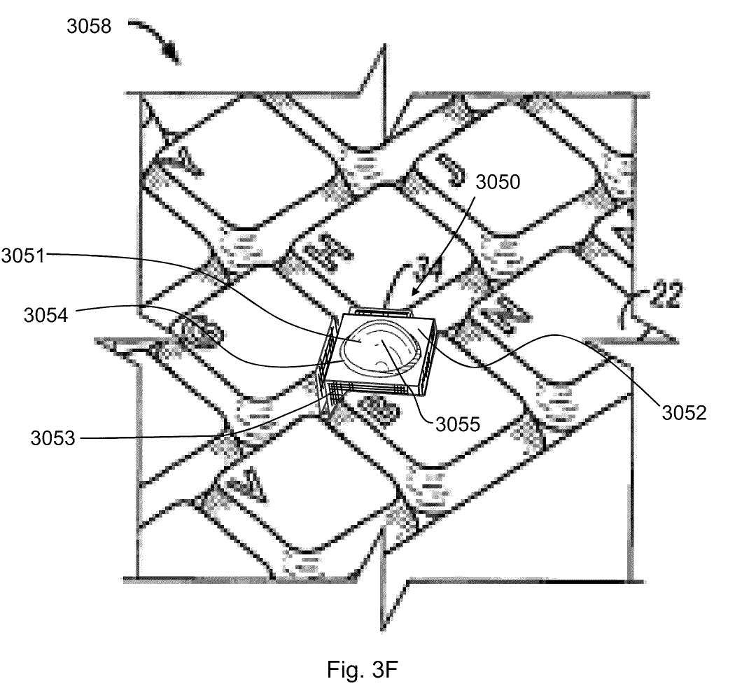

FIG. 2D is a perspective view of laptop 260. Laptop 260 comprises a display section comprising a display 266 in a display housing 267 and a keyboard section 264 comprising an alphanumeric keyboard 261 comprising two stick-type cursor control devices, a first device 275 and a second device 276, equidistant from the vertical (y) center of the keyboard. If keyboard 261 is a QWERTY keyboard, then first cursor control device 275 is situated between the F, G and V keys, and second cursor control device 276 is situated between the H, N and J keys. The top surface of each trackpoint is flush with or slightly above (z) the top surface of the adjacent keys. Laptop 260 also comprises four equal-size mouse buttons 271 aligned parallel to and just below the space bar, and centered under the B key 274, for use in conjunction with the two cursor control devices 275 and 276. In one embodiment, mouse buttons 271 are replaced by a set of two, equal-size buttons, and in one embodiment, mouse buttons 271 are replaced by a set of three mouse buttons aligned in the same way, wherein the middle button is about twice as wide as the left and right buttons (similar buttons are part of keyboard 3030 in FIG. 3E). Cursor control devices 276 and 275 can operate only as mouse cursor control devices, only as four-way navigation devices, or as both. Devices 275 and 276 can be replaced by suitably sized scroll balls or trackballs

It is well understood how to make and use trackpoint mouse cursor control devices, and how to incorporate such a trackpoint pointer into a keyboard. It is also well understood how to enable two or more mouse cursor control devices to simultaneously control the same mouse cursor on a single computer. Therefore, it will be clear to those skilled in the art how to build and develop software drivers for the keyboards described here. It is also well known how to translate signals from a trackpoint mouse device into movement of a mouse cursor on a display and how to switch from mouse cursor to text cursor using a mouse cursor control device, and it will be clear to those skilled in the art how to translate certain signals from a trackpoint-type device into movement of a text cursor.

Incorporating a scroll wheel or other scrolling device into the center section of a keyboard will reduce the distance a typist has to move his or her hands from the home row to scroll. FIG. 3 is a plan view of a QWERTY keyboard 300 comprising a scroll wheel 301 incorporated in the center portion of the keyboard 300. Keyboard 300 can be any type of keyboard such as one for a laptop computer, netbook, desktop computer, hand held device or kiosk. If not a QWERTY keyboard, the scroll wheel 301 can be in an appropriately similar location on non-QWERTY keyboard. The scroll wheel 301 is situated between the G 302 and H 303 keys with its axis of rotation aligned with the A row's (i.e., the row containing the A key) centerline, and has a diameter such that it fits between the Q and Z rows without requiring changes to any keys in those rows, neither to their key caps nor to the key switches underneath them. A scroll wheel in this position is equally accessible using either hand, and operation of a scroll wheel 301 situated there with either index finger requires little or no movement of the user's hand, wrist or arm from their home typing positions. It is also between the left and right sections of the keyboard so it does not interfere with typing (a scroll wheel located between the 6 and 7 keys, the T and Y keys, and the B and N keys will also not interfere with typing as they are also between two keys operated with different hands; it can also be between two function keys, such as between the F6 and F7 keys). At least the G 302 and H 303 keys (or only one of them), or at least their key caps, must be narrowed in width to create space for the scroll wheel 301. More than just the adjacent keys can be reduced in width to make room for the scroll wheel; in this case keys may need to also be shifted away from the scroll wheel. For example, if the scroll wheel 301 is ¼ inch thick, about ⅛ or 5/32nds or 3/16ths of an inch needs to be removed from each key (this may require a smaller key switch in addition to a smaller key cap). If keyboard 300 is a standard, full-sized keyboard, the letter keys 304 will occupy a space measuring about ¾″ wide (x) by ¾″ long (y), with the keys sized slightly smaller for clearance, and removing the amounts just mentioned from each of the H and G keys will result in H and G keys that are between ⅝″ and 9/16″ wide, still sufficiently wide for convenient use in typing Gs and Hs. In fact, the flat top surface of the key caps with which a finger comes in contact when operating a letter key on a standard size keyboard is generally only about one-half inch square, and the reduction in key width necessary to make room for the scroll wheel may leave a flat area that is as big or nearly as big. Moreover, the scroll wheel can be made narrower, in which case less would need to be removed from each key's width, and the remaining key will be bigger. Scroll wheels can have many sizes, but a ¾ inch diameter scroll wheel will fit within the Y-dimension of a row of standard sized keys. If a larger scroll wheel is desired, appropriate portions adjacent keys in the row above or below can be removed. The top of the scroll wheel is preferably at least as high (z) as the top of the adjacent keys, and preferably slightly higher.

Keyboard 300 also comprises four navigation keys 308 aligned horizontally below the space bar and centered under the B key. Navigation keys in this position are easy to operate with either thumb without moving the operating hand from the home row typing position. The four navigation keys 308 can be the same size as the letter keys of the keyboard (e.g., ¾ in squared) or a different size. In one embodiment, the keys 308 are as wide in their x-dimension as a letter key, but have a reduced height or y-dimension so that less space is required between the space bar and the front of the keyboard housing (new so-called netbook computers typically have little space between the spacebar and the front edge of the keyboard housing). Keyboard 300 also comprises a touchpad 306 in the lower right-hand corner under the right-hand shift key, and two mouse buttons 307 aligned horizontally below the touchpad 306 between it and the front edge of the keyboard housing. Touchpad 306 is located in an area which on some keyboards, such as some notebook computer keyboards, would otherwise at least partially have been occupied by the navigation keys 308. Keyboard 300 contains within the space normally occupied by a notebook computer keyboard or the keyboard section of a netbook a scroll wheel, navigation keys, and a touchpad, enabling the scrolling, text cursor control and mouse cursor control without requiring additional devices or laptop housing real estate.

FIG. 3A is a plan view of the portion of keyboard 300 comprising the scroll wheel 301 and the G and H keys. Scroll wheel 301 has an axle 312 which is supported by the substrate 313 or some other part of the keyboard housing (not shown). Keyboard 300 incorporated into a housing 305 which can be the housing of a peripheral keyboard, a notebook computer, a netbook or some other device with an alphanumeric keyboard interface. A substrate 313 supports the H and G keys, electrical connectors and key switches (only that portion supporting the G and H keys is shown). An opening 311 is formed in the substrate 313 to permit the scroll wheel 301 to pass through the substrate 313 (typically a printed circuit board or PCB). The underlying key switch mechanisms for the G and H keys may need to be shifted away from the center of the keyboard to make room for the scroll wheel 301, or a smaller width key switch may needed for each key. The keyboard, and if the keyboard is part of a laptop, the laptop itself, may have to be modified internally to account for the presence of the scroll wheel. Although only the scroll wheel may be visible, other scroll wheel components will be within the keyboard or laptop housing, and other keyboard and laptop components may need to be changed or adjusted to make room for the scroll wheel and its components. For laptop computers where the scroll wheel may interfere with closing the display section if it sticks up (z) to much, the scroll wheel (itself or the entire unit) may be mounted on springs allowing the scroll wheel to be pushed down if the display hits it when closed. In one embodiment, the scroll wheel is mounted on a powered lift that moves the scroll wheel up and down in the Z direction (i.e., orthogonal to the plane of the keyboard).

Keyboards can incorporate scroll wheels and other scrolling devices with other types of cursor control devices. In one embodiment, a keyboard incorporates a scroll wheel situated between the G and H keys, and two trackpoint-type cursor control devices as in keyboard 200 in FIG. 2, the first situated between the F, G and V keys, and the second between the H, J and N keys. In one embodiment, one or both of the trackpoint-type devices is replaced by a mini trackball, and both can operate either as a four-way navigation device, a mouse pointer, or both.

Scrolling devices and pointing devices generally allow user configuration and also may have more functionality than just scrolling or moving the cursor. For example, scroll wheels can often be pushed down to execute a function like a right click or changing the scrolling mode. Any of this additional functionality of scrolling and pointing devices can be part of any device incorporated into a keyboard as described here.

FIGS. 3B and 3C show how a scroll wheel can be incorporated into a keyboard. FIG. 3B is a perspective view (from US patent application US20070152970(A1) of scroll wheel assembly 361 which has side scrolling functionality. FIG. 3C is a perspective view of a keyboard support board 360 with scroll wheel assembly 361 mounted to its underside. Referring to both FIG. 3B and 3C, mounting posts 340, each comprising a threaded hole 341, have been attached to the scroll wheel assembly's 361 support board 51 in its four corners to allow for the assembly 361 to be mounted at the proper distance (z) under the keyboard's circuit board 360 so that the scroll wheel 363 will protrude up through a slot 365 cut in the keyboard PCB 360. The height (z) of the posts 340 is enough to provide clearance when mounted under the board 360 for the scroll wheel carrier 532 to move freely to enable side to side action of the scroll wheel 363 (for scroll wheels not enabled for side-to-side operation less clearance will be needed). Holes 362 (preferably countersunk) in the keyboard circuit board 360 are aligned with the posts 340 on the scroll wheel assembly circuit board 51, and screws 366 pass through holes 362 into threaded holes 341 in the posts 340. Key switch assemblies 370 (only one is shown), comprising a key switch 369 and key cap 368, are mounted in the locations shown in outline 364 to the top side 367 of the circuit board 360. Key switch assemblies 370 for the G and H keys must fit in the spaces 364G and 364H on either side of the scroll wheel 363, which are narrower (x) than the space allotted to other key switch assemblies 364 in order to make room for slot 365. Alternatives will be obvious. The width (measured parallel to the axle of the scroll wheel 363) of support board 51 can be reduced significantly to allow the scroll wheel assembly 361 to be mounted a smaller volume, such as to the front of the keyboard housing where the separation between the inside surfaces of the top and bottom sides of the housing may be somewhat or considerably less than an inch.

Scroll wheels incorporated within the keys of a keyboard can be very thin to minimize the amount of modification of adjacent keys necessary to create room for the scroll wheel. A very thin scroll wheel such as one ⅛ or 3/16 or 1/16 inch thick will be an unobtrusive addition to a keyboard. The diameter of such scroll wheel can be the same roughly ¾ inch Y dimension of the keys of a standard keyboard or it can be bigger (such as ⅞ or 1 or 1.25 inches). Scroll wheels can also be oriented with their axis of rotation perpendicular to the rows of keys. Scroll wheels so oriented can be positioned between any two adjacent rows of keys, including between the Z row and the space bar, preferably centered in the keyboard. Modifications to the keys adjacent to the scroll wheel may need to be made to provide room for the scroll wheel. Using a thin profile scroll wheel will reduce the size of the modifications necessary to the adjacent keys.

Just as moving stick-type cursor control devices away from the center of the keyboard can make them more convenient to use, moving the scrolling device away from the center of the keyboard can make scrolling easier. In this case it may make sense to have two scroll wheels symmetrically located around the center of the keyboard, each within easy reach of the fingers of one hand. FIG. 3D is a top plan view of a QWERTY keyboard 3010 comprising keys 3013, a first scroll wheel 3011 situated between the F and G keys and a second scroll wheel 3012 situated between the H and J keys. Both scroll wheels 3011 and 3012 are thin profile scroll wheels about ⅛ or less inches thick and sized to fit within the y-dimension of the A row. Because they are thin profile, the adjacent keys need only be reduced slightly in width, about 1/16 inch each.

All of the scroll wheels that are part of any embodiment of the invention described here are part of a scroll wheel assembly such as scroll wheel assembly 361 in FIG. 3B, and will generally comprise, in addition to the scroll wheel, at least a carriage or bracket for supporting the scroll wheel or its axle in such a way that the wheel can spin freely, one or more detectors or sensors capable of detecting or sensing movement of the scroll wheel around its axis, and optionally side-to-side and/or up and down, an electrical connection to a power source and to a processor capable of converting signals from the sensors or detectors into scrolling on a display, and a means for mounting the scroll within the keyboard assembly housing, such as to the support for the keys or to the housing. The only part of a scroll wheel device that will generally be visible to a user (and which is shown in most of the figures herein) is the scroll wheel which protrudes up through an opening in the keyboard support past the keys to where it can be operated by a user's finger. The remainder of the scroll wheel device will be housed within the keyboard housing, or in some cases partly within its own housing if the keyboard housing is shallower than the diameter of the scroll wheel minus that part of the wheel that extends above it and the scroll wheel device extends past the bottom of the keyboard housing. There are many different scroll wheel devices made by many different manufacturers, and the scroll wheel devices incorporated into keyboards of the present invention can be any of those, provided such scroll wheel device is of the appropriate size and functionality. In embodiments where the scroll wheels herein are mounted in the front of a keyboard assembly housing, the scroll wheel devices are designed to fit within the confines of that section of the keyboard housing.

If a scroll wheel is incorporated among the keys of a laptop computer, it may interfere with the closing of the laptop, and may even damage the display. One way to avoid this is for the scroll wheel to have two positions, a first position for use and a second position for storage. In one embodiment this is accomplished by mounting the scroll wheel to a solenoid that moves scroll wheel up and down. When the solenoid is powered on, the scroll wheel will be pushed up into its operating position with the top of the scroll wheel above the top of the adjacent keys, and when it is powered off it will fall or be pulled by a spring back to its lower rest position with the top of the scroll wheel below the top of the adjacent keys. The distance the scroll wheel has to move may be only ⅛ or ¼ inch. In order to insure that the scroll wheel is not in the operating position when the laptop display section is closed down on the keyboard section, the electrical connection to solenoid can be made by opening the laptop clamshell to a certain point and broken by closing the laptop clamshell at least as far as that certain point. Thus, even if the computer is powered up, it cannot provide power to the solenoid once the clamshell has closed past that certain point. Most laptops contain a similar mechanism for determining when the laptop is open or closed, and that mechanism can be used to make or break power to the solenoid lifting the scroll wheel.

There are other types of scrolling devices such as scroll balls and scroll strips. Miniature scroll balls are found on certain devices such as the Apple® Mighty Mouse and some Blackberry® phones which are small enough to occupy a space of similar size to that occupied by a trackpoint device. There are also mini/micro trackballs which are small enough to fit into a standard keyboard and replace a trackpoint device (for example, the TrackballWorld TB522 Thumbelina™ Micro-Presenter) for use in scrolling, as a mouse cursor control device, or as a four-way navigation device. FIG. 3F shows a segment of a QWERTY keyboard 3058 incorporating a ball-type cursor control device 3050 comprising ball 3051 held in mount 3052 by ring 3054. Keyboard segment 3058 can be part of a laptop, desktop or other type of keyboard. Preferably the ball 3051 is mounted such that its top surface 3055 is flush with or slightly above the top surface of the surrounding keys 22. Housing 3053 supports ball at the right level relative to the adjacent keys and may also enclose some of the other components of ball-type device 3050; other components are mounted below the keyboard support or within the keyboard housing. It is mounted solidly to the support for the keys of the keyboard (not shown) or to the keyboard housing under the keyboard support. In one embodiment, ball-type cursor control device 3050 is a scroll ball. In one embodiment, it is a trackball type mouse cursor control device. In other embodiments, the trackpoint- or stick-type device in embodiments of the present invention described elsewhere herein are replaced by a mini or micro ball-type cursor control device such as ball-type cursor control device 3050, and in some embodiments, keyboards incorporate such devices along with other types of cursor control devices such as track points.

Touch-sensitive scroll strips, such as that found on Logitech's V500 Cordless Notebook Mouse and many home appliance control panels, can also be integrated into keyboards described here in the same position as the scroll wheel. The scroll strip is sized to be roughly that of the maximum cross-section of the scroll wheel parallel to the axis (e.g., a scroll strip about ¼ or ⅜ inches wide (x) and about ¾ inches long would easily fit between two letter keys, such as the G and H key, with slight modification to the adjacent keys).

FIG. 3E is a plan view of a split keyboard 3030 comprising a left half 3037 comprising those keys 3022 operated with the left hand and a right half 3038 comprising those keys operated with the right hand with a gap 3039 in between, a scroll wheel 3031 situated between the right end of the Q row of the left half 3037 adjacent to the T key and the left end of the P row of keys of the right half 3038 adjacent to the Y key with its axis of rotation centered on and parallel with the rows, a cursor control device 3032 situated between the right end of the A row of the left half 3037 adjacent to the lower right side of the G key and the right end of the H row of the right half 3038 adjacent to the lower left side of the H key, and three mouse buttons, left 3041, middle 3042 and right 3043 aligned horizontally in that order below the space bar centered under device 3032. Unlike the split keyboard shown in FIG. 2C, the two halves 3037 and 3038 are not at angles to each other; rather, the rows of keys of the left 3037 and of the right 3038 halves of the keyboard 3030 are aligned with each other. The gap 3039 is at least wide enough to fit a scroll wheel 3031 with its axis parallel to the rows without necessitating any changes to the keys adjacent to it. This gap 3039 can range from ⅛ inch or so to accommodate a thin profile scroll wheel less than ⅛ inch thick, or up to ½ inch or ¾ inch or more to accommodate a standard profile scroll wheel measuring ¼ or ⅜ inch in thickness. The scroll wheel 3031 can be anywhere in the gap 3039, and in other embodiments it is between the B and N keys, the G and H keys (where it would be centered between a typist's two hands), the 6 and 7 keys, or two function keys separated by the gap 3039. Scroll wheel 3031 has a diameter approximately equal to or slightly less than the y dimension of a row (typically about ¾ inch) so that it can fit between adjacent rows without requiring either changes to the keys in those rows or an increase in the width (x) of gap 3039, but could be larger in diameter in other embodiments.

In one embodiment, keyboard 3030 is a laptop keyboard, a desktop computer peripheral keyboard, or any other type of keyboard. Cursor control device 3032 is shown as a stick-type device such as those described elsewhere herein capable of operating as a four-way navigation device or a mouse, or both, or can be a mini-trackball, or a mini-scroll ball, and can be located anywhere in the gap 3039, including between the T and Y keys if the scroll wheel is eliminated; its location in keyboard 3030 between the G and H keys centers it in the keyboard. If necessary to accommodate a larger device, gap 3039 can be made wider, such as ¾ to 1 inch without making the keyboard too wide to fit in most laptop computers or keyboard peripherals. However, the narrower the gap 3039, the more familiar the keyboard 3030 will seem to users not used to using split keyboards, and the more it will operate like a standard, straight-rowed keyboard.

The left button 3041 and the right button 3043 are similarly width and the middle mouse 3042 is about twice as wide in the x-dimension. The height or y dimension of the three buttons is the same in this embodiment. This configuration of three mouse buttons with extra wide middle button flanked by two smaller buttons is more ergonomic than the standard pair of two equally sized mouse buttons used with touch pads and trackpoints. Prior art mouse buttons are uncomfortable and unergonomic to operate because operating the button to the same side as the hand operating the touchpad or trackpoint (i.e., the left button with the left hand) generally requires bending of the thumb at its proximal interphalangeal joint which is more stressful than keeping the thumb mostly straight and bending it mostly at its metacarpophalangeal joint. It is uncomfortable to bend the thumb inwards towards the palm to operate the right button for right-handed users and the left button for left-handed users. While the three buttons can be configured to operate as the three buttons on some computer mice, for ergonomic use, the middle button 3042 and one of the other two buttons are configured to operate as either the left or right mouse button, and the other of the two buttons is configured to operate as the other mouse button. In practice, for right-handed operation of the stick-type cursor control device 3032, the left button 3041 is configured to function as left mouse button and the other two buttons 3042 and 3043 are configured to both operate as right mouse buttons; and for left-handed operation of the stick-type cursor control device 3032, the right button 3043 is configured to function as right mouse button and the other two buttons 3041 and 3042 are configured to both operate as left mouse buttons. By thus configuring the mouse buttons 3041-43, the amount of bending of the thumb necessary for a right-handed person to operate the right mouse button and for a left-handed person to operate the left mouse button is minimized, making the buttons more ergonomic to use.

Prior art mouse buttons for laptop computer trackpoints and touch pads range in width from about 1 to 1.5 inches and in height (y) from about ½ to ¾ inches, although there are many different sizes used. Left button 3041 and right button 3043 can be about 0.75 inch wide by ½ or ¾ inch high (y) while middle button 3042 can be about 1.5 inch wide by 0.5 or 0.75 inch high (y), although those dimensions can vary. Sets of three buttons sized similarly or slightly smaller will occupy roughly the same space as is occupied by prior art pairs of mouse buttons, and will, for instance, fit within the same width as a typical touchpad. The left 3041 and right 3043 buttons can be increased in width to be closer in size to the middle button 3042. These improved ergonomics can be maintained by replacing the three buttons 3041-3 of keyboard 3030 with the four buttons 208 of keyboard 200 in FIG. 2A. The improved ergonomics can also be maintained by replacing middle 3042 and right 3043 buttons with a single extra wide button having a width roughly equal to the sum of the widths of the two replaced buttons, or by replacing left 3041 and middle 3042 buttons by a similar extra wide button; the former buttons are for right-handed operation of the trackpoint 3032, and the latter buttons are for left-handed operation of trackpoint 3032. In this case, for a left-handed operator of device 3032, the right-most button 207 is configured as a right mouse button and the other three buttons 204-6 are configured to operate as a left mouse button (some left-handed users may prefer to reverse the buttons, so the right-most button 207 would be configured as the left mouse button and the other three buttons 204-6 as the right mouse button; the same can be done when configuring the three buttons 3041-3), while for a right-handed operator of device 3032, the left-most button 204 is configured as a left mouse button and the other three buttons 205, 206 and 207 are configured to operate a right mouse buttons. Configured this way, the amount of bending of the thumb at its proximal interphalangeal joint is minimized and most bending of the thumb is only at the metacarpophalangeal joint. This is especially helpful with touchpads where, for example, a right handed user may be operating at the left edge of the touchpad and need to bend his or her thumb back considerably to operate the right mouse button; when using the new three or four button mouse buttons configured as just described, such a user would only have to bend his or her thumb back slightly. The set of four buttons can be configured in other ways, such as described earlier, or simply the two right-most buttons configured to operate as one type of mouse button and the two left-most buttons configured to operate as the other type of mouse button.

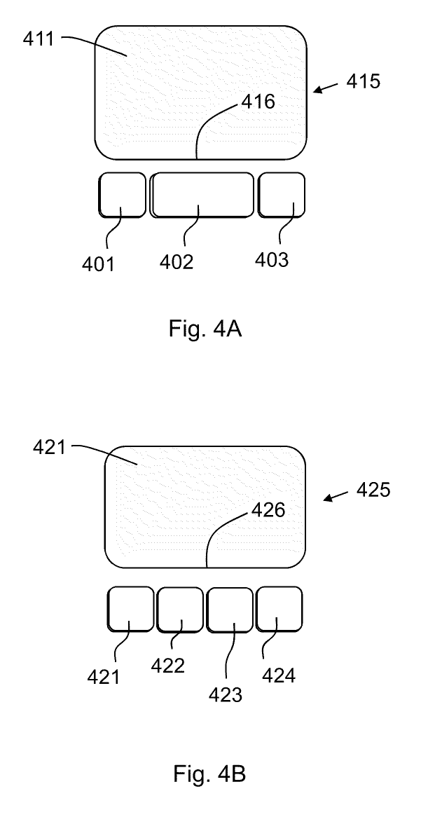

Sets of three and four mouse buttons can be used with any type of mouse cursor control device, especially those configured so that the cursor is controlled using one finger and the mouse buttons are operated using the thumb of the same hand. These include stick-type devices such as the trackpoint, some trackballs, and touchpads, both those incorporated into a keyboard or laptop computer and peripheral devices which can plug into a laptop or other computer. The ergonomic issues associated with operating mouse buttons are exacerbated with touchpads because unlike trackballs and trackpoints, the hand moves considerably relative to the mouse buttons (most are 2-3 inches wide and 1.5-2.5 inches high) while controlling the mouse cursor, and the thumb of the operating hand is more likely to have to bend back significantly at its proximal interphalangeal joint to reach a button. Operating a button to the side of the touch pad's vertical centerline towards the palm of the hand being used is more uncomfortable than operating a button on the other side of the centerline. FIG. 4A shows a plan view of a touchpad assembly 415 comprising a touchpad 411 and three mouse buttons aligned horizontally and centered below its bottom edge 416, a left 401, middle 402 and right 403 buttons, with left 401 and right 403 buttons of equal size and middle button 402 about twice as wide, with the three buttons sized to fit within the width of the touchpad 711. For example, if touchpad 411 is 2.75 inches wide, buttons 401 and 403 can be about 0.75 inches wide and button 402 can be about 1.25 inches wide. FIG. 4B is a plan view of a touchpad assembly 425 comprising touchpad 421 and four equal-width mouse buttons aligned horizontally and centered below its lower edge 426, left 421, middle left 422, middle right 423 and right 424 buttons, and fitting within the width of the touchpad 421. The mouse buttons of these two touch pads can be configured as described above. In other embodiments, touchpads 415 and 425 are part standalone peripherals or part of another device such as keyboards, notebook or netbook computers, and kiosks.

The thumb is the most dexterous of the five fingers, yet it is hardly used by those typing with full-sized keyboards. Typically the thumb is only used to operate the space bar, although some keyboard operators may use their thumb to operate the touchpad and, on keyboards incorporating a trackpoint device, to operate the mouse buttons while simultaneously operating the trackpoint device with a finger. On the other hand, handheld devices such as phones and PDAs, however, exploit the dexterity of thumbs. Thumbs are the preferred digits to use when texting using a phone keypad, miniature QWERTY keyboard or other type of keyboard, when operating a device with a touch screen interface such as an Apple iPod Touch, iPhone or Blackberry Storm, and when operating an iPod click wheel or the equivalent. Many Blackberry smart phones incorporate a thumb operated click-wheel.

Some prior art keyboards, especially laptop computer keyboards, incorporate a scrolling device below the space bar. However, no full-size keyboards make use of the front side of the keyboard housing by positioning a scrolling or cursor controlled device there that can be operated using a thumb. When a user has his hands in the touch typing home positions, the thumb is naturally in a position where operating a device mounted in the front side of the keyboard's housing is easy and comfortable. Devices that can be mounted in the front side of a keyboard housing for thumb operation include a scroll wheel, scroll ball, scroll strip, navigation keys, four-way navigation device, touch pad, trackball, trackpoint (stick-type mouse), or functional keys (e.g., delete, tab).

Provided the distance in the y-direction of the front side from the bottom row of keys is less than about an inch, most users will be able to operate with their thumbs a cursor control or scrolling device mounted and centered in the front side of the keyboard housing without moving their other fingers from the home row positions, although the shorter that distance, the easier it is. If that distance is much greater than one inch, the user may have to move his or her hand slightly to operate the device. Since the placement of the keyboard within the housings of the keyboard section of most laptop computers is away from the front side and close to the hinge between the display and keyboard sections of the laptop, the front side of the keyboard section housing is generally more than one inch from the bottom row of keys of the keyboard, and users of laptop computers will most likely have to move their hands somewhat to operate a cursor control or scrolling device mounted in the front side of the keyboard section housing. However, those devices will still be convenient, easy and ergonomic to operate using a thumb, especially in a cramped location such as a middle seat in economy on an airplane. Netbooks, a subclass of notebook computers, have very little space between the space bar and the front side of the keyboard section housing, and therefore devices built into the front side of a netbook computer are operable while one's hands are on the home row keys.

Keyboard housings and the housings of the keyboard section of laptop computers are generally rough regular hexahedrons with six roughly rectangular sides: a top side into which the keyboard's keys are mounted (the top side and the keyboard are in the same plane); a bottom side which sits on some supporting object like a table or lap when the keyboard is in use and which is generally roughly parallel to the front side; a front side which faces the user when the keyboard is in use [closest to the bottom row of the keyboard, which typically contains the space bar]; a back side which faces away from the user when the keyboard is in use [closest to the top row of the keyboard] and is generally more or less parallel to the front side; a left side which is to the left of the keyboard's center when the keyboard is in use; and a right side which is to the right of the keyboard's center when the keyboard is in use and is generally parallel to the left side—the front, back, left and right sides are more or less orthogonal to and between the top side and the bottom side of the keyboard housing. When in use the keyboard and keyboard section housings are generally oriented with the front side toward the user, the bottom side resting on some support, the top side up and accessible, the back side away from the user, and the right and left sides somewhat to the right and left of the user respectively. Split keyboards typically have a front side which is not straight, so the front side of the keyboard housing is often not a flat plane. Some keyboards have a curved front side while in others the top side slopes down to meet the bottom side and there may not be a front side at all. Those of skill with keyboard design will find it easy to adapt the present invention to those types of keyboards as well.

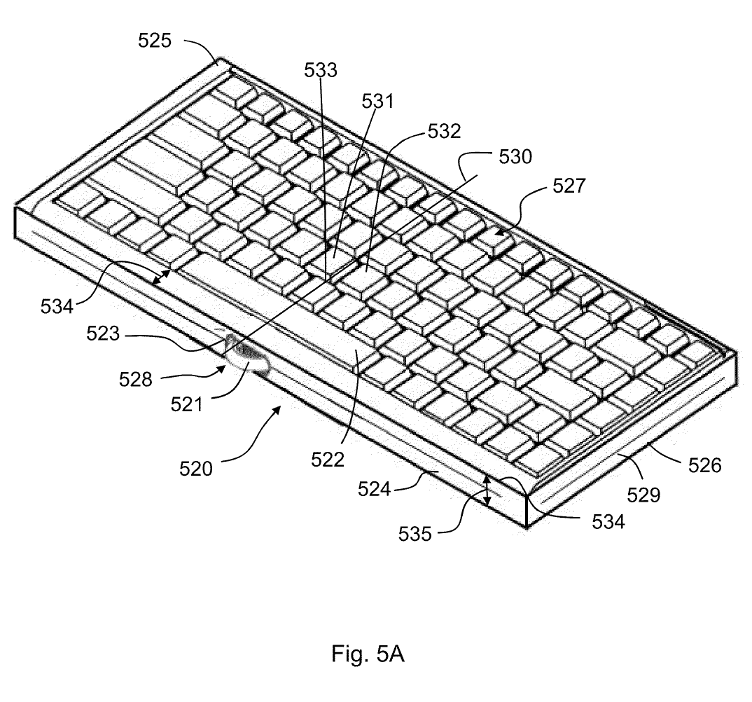

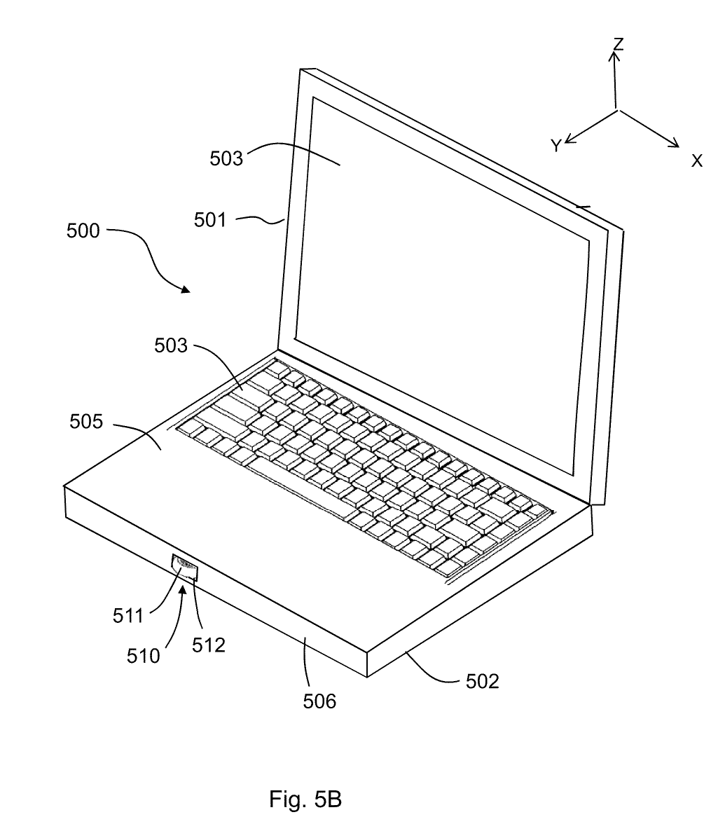

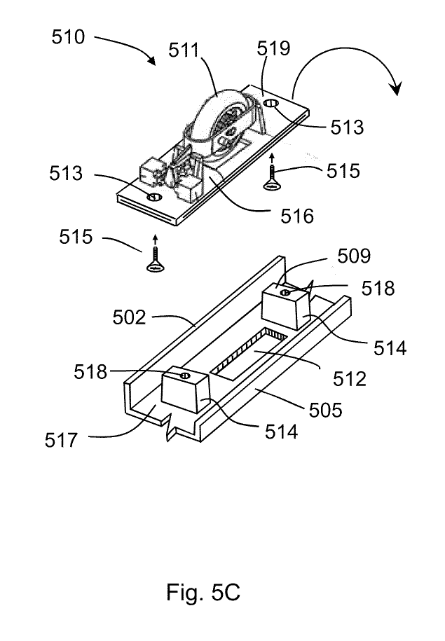

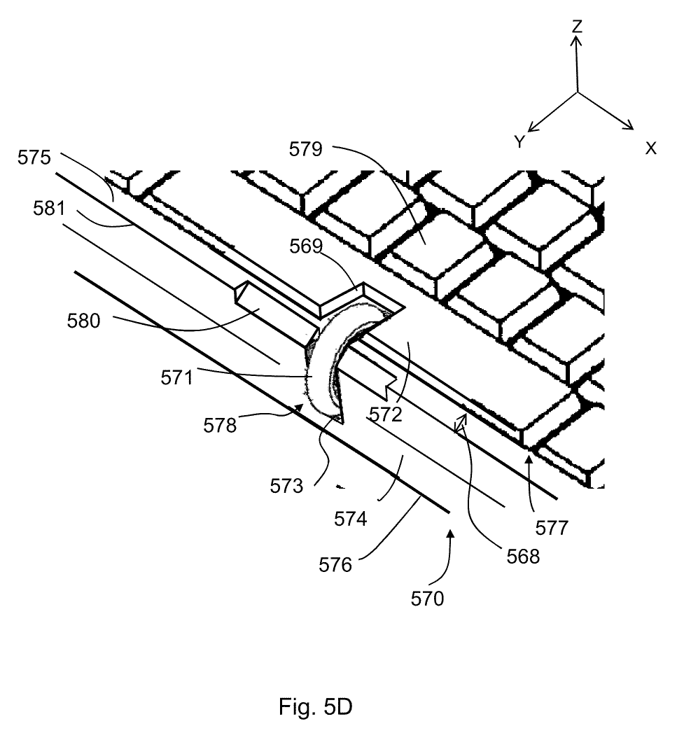

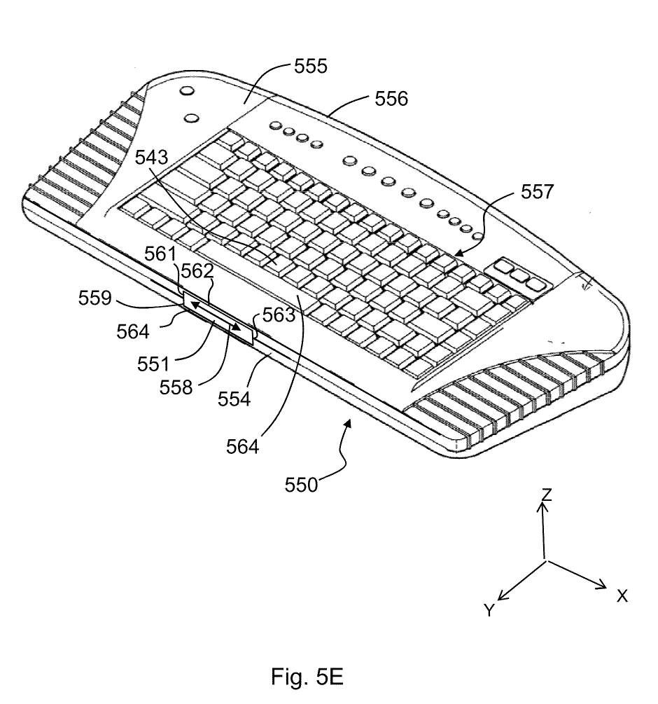

FIG. 5A shows a prospective view of keyboard assembly 520 which comprises a keyboard housing 526 comprising a top side 525, a right side 529 and a front side 524 (also a back side [opposite the front side 524], a left side [opposite the right side 529] and a bottom side [opposite the top side 525] which are not shown), the latter of which 524 faces the user when the keyboard 527 is in use; an alphanumeric keyboard 527 incorporated into the top side 525 of the keyboard housing 526; and a scroll wheel assembly 528 contained mostly within the keyboard housing 526 and mounted to or proximate to the inside surface of the front side 524 such that its scroll wheel 521 protrudes partially through a slot 523 in the front side 526. The scroll wheels's axis of rotation is roughly parallel with the Z axis so that the scroll wheel 521 spins roughly in the plane of the keyboard. The scroll wheel assembly 528 is sized such that it can fit inside the keyboard housing 526 in its horizontal orientation with the scroll wheel 521 protruding out through slot 523 from the front 524 of the keyboard housing 526 a distance similar to the distance a typical scroll wheel of similar diameter protrudes beyond the surface of the housing of the device, such as a mouse, into which it is incorporated. Scroll wheel 521 is roughly centered in the front side 524 in both the x and z directions. As with all other scroll wheels and the scroll wheel assemblies of which they are a part incorporated into keyboards described herein, scroll wheel assembly 528 is electrically connected to a power source and to a processor or other device that translates the signals generated by movement of the scroll wheel 521 into scrolling movement on a display.

The scroll wheel 521 is positioned to be operated using the thumb of either hand. In this embodiment, the scroll wheel 521 is centered in the keyboard relative to a typists hands when in the touch typing position, aligned in the y-direction with the B key 533 (center line 530 bisects the B key 533 and passes between the G 531 and H 532 keys), but it can be to the left or right of the center of the keyboard. Scroll wheel assembly 528 can be any type of scrolling wheel, including a standard scroll wheel such as those incorporated into may computer mice, a thin profile scroll wheel, and a scrolling wheel of the type found on many Blackberry® PDAs and phones, such as the 8700 series of phones. In one embodiment, the scroll wheel assembly 528 is the scroll wheel assembly 361 shown in FIG. 3B. The scroll wheel or wheels in any embodiment of the present invention described here which incorporates a scroll wheel can have both side-to-side scrolling and click functionality. The keyboard assembly 520 is a peripheral keyboard that can be connected to a computer, and can be a keyboard in any layout and language. Dimension 531, the distance between the bottom of the bottom row of keys containing the space bar 522 and the top edge 534 of the front side 524 will typically be less than one inch, although it varies from ⅛ inch or less to several inches. The height (z) 535 of the front side, and the amount of space within the housing 526 between the inner surfaces of its top side 525 and bottom side, can be increased to accommodate scroll wheel assembly 528 or scroll wheel assembly 528 can be modified to fit within the space provided by the housing 526. Some keyboard housings have front sides that slope away from the top side at less than a 90 degree angle; in those keyboards, the scroll wheel's axis of rotation will preferably remain roughly parallel to the Z axis.

In one embodiment, the scroll wheel assembly 528 is oriented as shown in FIG. 5A but mounted substantially away from the center of the keyboard, such as about 3, 4, 5, or 6 inches to either side of center of the alphanumeric section of the keyboard (typically aligned under (y) the B key). A scroll wheel in this position is intended for use with the thumb of the opposite hand, and in particular is useful on laptop computers for use in crowded confines such as airplane economy seating.

In one embodiment, there are two scroll wheel assemblies mounted in the keyboard housing 526 with their scroll wheels protruding beyond the front side 524 an appropriate distance for operation and their axes parallel to the Z axes. In one embodiment, the two scroll wheels are positioned a short distance (1 inch or so) to either side of the center of the keyboard so each is easy to operate with either the left or the right thumb. In another embodiment, the two scroll wheel assemblies are mounted symmetrically roughly 2, 3, 4, 5 or 6 inches to either side of the center of the keyboard 527. Scroll wheels in such positions are intended to be operated with the thumb of the opposite hand from that operating the nearest alphanumeric keys.

In another embodiment, there is a scroll wheel assembly incorporated into the keyboard assembly such that the scroll wheel protrudes out of the left, the right or both the left and right sides of the keyboard housing, preferably oriented such that its axis of rotation is perpendicular to the plane of the keyboard. Scroll wheels in such positions are intended to be operated using one of the user's four fingers, most likely the index or middle finger of the hand corresponding to the side of the keyboard housing from which the scroll wheel protrudes. One appropriate position is closer to the hinge between the display and keyboard halves of the laptop than to the front side of the keyboard housing.

A scroll wheel can also be built into the front side of the housing of the keyboard section of a notebook computer (including netbooks and other clamshell-type portable computers). A perspective view of a laptop 500 is shown in FIG. 5B. Laptop computer 500 comprises a display 503 in the display portion of the housing 501, an alphanumeric keyboard 503 incorporated into the top side 505 of the keyboard section of the housing 502, and a scroll wheel 511 protruding through a slot 512 in the front side 506 of the keyboard section housing 502, which is roughly orthogonal to the top side 505 and faces the user when the laptop 500 is in use. The axis of rotation of scroll wheel 511 is roughly perpendicular to the top side 505 (parallel to the Z axis) so that the user spins the scroll wheel 511 using motions of a thumb roughly parallel to the rows of keys. The scroll wheel 511 is part of a scroll wheel assembly 510, most of which is located with the keyboard section housing 502, and the wheel 511 protrudes as much as any similarly sized scroll wheel that is part of another device, such as a mouse, protrudes through that device's housing. The scroll wheel assembly 510 needs to fit within the Z dimension of the keyboard section housing 502, and can be mounted to the inner surface of the front side 506 or top side 505 or bottom side (not shown, but opposite and roughly parallel to the top side 505), or to another component within the keyboard section housing 502. The scroll wheel assembly 510 is preferably located where it is equally accessible to the thumb of either hand when in normal typing positions, which for a QWERTY keyboard means it is preferably aligned with the B key in the y-direction. The scroll wheel assembly 510 can also be located off-center, either by a small amount such as one inch in either direction, or by 2, 3, 4, 5 or more inches. A second scroll wheel assembly can be incorporated into the front side 506, or into the left or right sides, of the keyboard section housing 502.

FIG. 5C is a perspective cutaway view of the inside of keyboard section housing 502 showing how scroll wheel assembly 510 is mounted in the front of a laptop computer 500 (a similar approach can be used to mount a scroll wheel to the front of a keyboard peripheral housing). Scroll wheel assembly 510 comprising scroll wheel 511 and support 516. Support 516 has two holes 513 formed in it for mounting to the keyboard section housing 502 using screws 515. Keyboard housing 502 has a slot 512 formed in it big enough to permit passage of at least a portion of scroll wheel 511 so that it is accessible from the housing's front side 506. The inside 517 of keyboard housing 502 has two raised posts 514 with holes 518 formed in them for accepting screws 515. Support 516 is attached to the posts 514 using the screws 515 or some other means. Note that scroll wheel assembly 510 is shown upside-down with relation to the housing 502; to assemble the assembly 510 into the housing 502 it must first be flipped over (the screws 515 are shown entering from the correct side of the support 516) so that first side 519 of support 516 is flush against the top side 509 of posts 514.

FIG. 5D shows a portion of a keyboard assembly 570 comprising a housing 576 having a front side 574 and a top side 575 roughly orthogonal to each other, a keyboard 577 incorporated into the top side 575, and a scroll wheel assembly 578 incorporated into the housing 576 such that the scroll wheel 571 protrudes through a slot in both the top and front sides of the housing where the two sides meet. The axis of rotation of the scroll wheel 571 is parallel with the rows of keys of the keyboard (i.e., with the x axis of the keyboard). Because the gap 568 between the bottom row of the keyboard 577 containing the space bar 572 and the top edge 581 of the front side 574 where it meets the top side 575 is too small to provide adequate space for the scroll wheel 571, a notch 569 is formed in the space bar 572 in its side closest to the front side 574, the notch 569 of sufficient size to accommodate the scroll wheel 571. The scroll wheel 571 is centered under (y) the B key 579 for easy access by both hands and so, therefore, is the notch 569. Since it is easy to operate the space bar without pressing the area directly under (y) the B key, it is easy for a typist to avoid inadvertently pressing the space bar 572 while operating the scroll wheel 571. Scroll wheel 571 protrudes above (z) the top surface of the space bar 572 and out from the front 574 outer surface roughly one-eighth or three-sixteenths of an inch (it can protrude more or less) to enable easy operation by a user (it should protrude above the surrounding surfaces an amount similar to the amount existing scroll wheels in computer mice protrude above the surfaces surrounding them). To further improve ease of use of the scroll wheel 571, the front edge 581 of the keyboard housing 576 can optionally be beveled to create a beveled surface 580 at about a 45 degree angle to the top 575 and front 574 sides and roughly 1-3 inches wide (x) and extending to either side of slot 573. The bevel 580 makes it easier to use the scroll wheel without interference from the housing 576.

FIG. 5E shows a prospective view of peripheral keyboard assembly 550 which comprises an alphanumeric keyboard 557 incorporated into a top side 555 of a keyboard housing 556 also having a front side 554, and a touch sensitive strip 551 for scrolling which is situated in roughly the center of the front side 554. The touch sensitive scroll strip 551 is of the type found on some MP3 players (such as the iRiver H10), some computer mice (such as the Saitek Obsidian mouse and the Logitech MX Air mouse), or on other devices such as home appliances. Double arrow 558 indicates the direction a user must move his or her thumb across the touch surface of the scroll strip 551 to scroll up and down (whether moving to the left or right is up, and the opposite down, can be set at the factory or be user-configurable). The scroll strip 551 is aligned in the Y-direction with the B key 543 and so centered under the alphanumeric section of the keyboard from the touch typist's perspective. This makes the scroll strip 551 as easy to operate using the left thumb as it is using the right thumb. The scroll strip 551 is part of an assembly, a portion of which is within the housing 556. In this embodiment, the scroll strip 551 is a separate element from the keyboard housing 546, and an opening 559 is made in the front 554 of the keyboard housing 556 so that the touch-sensitive surface of scroll strip 551 can be mounted flush with the front sid 554 and be accessible to the user. In one embodiment, the front side of the housing 554 is touch sensitive and functions as a scroll strip where it is touch sensitive, thereby obviating the need for an opening 559. The scroll strip can be as long as the front side is wide. In one embodiment, the electronics for the scroll strip 551 are entirely within the housing 554. The strip 551 should be made sufficiently wide (in the direction of vector 558)—generally one or more inches, and high (z) enough—generally ⅜ or ½ or ⅝ inches, for easy use with a thumb. In one embodiment, the scroll strip 551 operates only in the direction of vector 558 such that any touch by a user is interpreted as either a stroke to the left or to the right. In one embodiment, the scroll strip 551 interprets movement across its surface in the Z direction as side-to-side scrolling, and is able to control movement of a mouse cursor. In one embodiment, touch-sensitive strip 551 is a mouse cursor control touchpad. In this embodiment, the user can define the orientation of the touchpad 551 (i.e., whether the left, 561, top 562, right 563 or bottom 564 edge of the touchpad 551 is up), and mouse buttons would be added to the keyboard assembly 550, for example, in the top side 555 centered below the space bar 564 or in the front side 554. In one embodiment, holding down a modifier such as the Ctrl or Shift key switches the scroll strip to navigation mode where it controls the text cursor. Moving a finger across the scroll strip while holding down a first modifier key moves the text cursor left or right, depending upon the direction of finger movement, and moving a finger across the scroll strip while holding down a second modifier key moves the text cursor up or down, depending upon the finger's direction.

Scrolling and cursor control devices can also be incorporated into the front side of the housing of a split keyboard. In split keyboards, each half of the keyboard can have its own cursor control device situated the same relative to the home keys for each hand as it is in the embodiments described. Scrolling devices and pointing devices generally allow user configuration and also may have more functionality than just scrolling or moving the cursor. For example, scroll wheels can often be pushed down to execute a function like a right click or changing the scrolling mode. Any of this additional functionality of scrolling and pointing devices can be part of any device incorporated into a keyboard as described here.

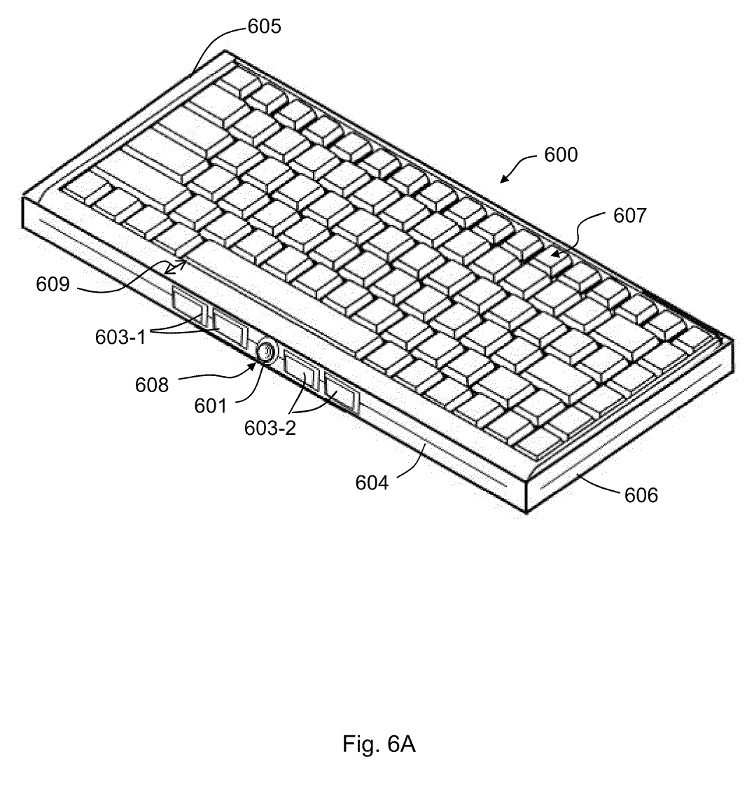

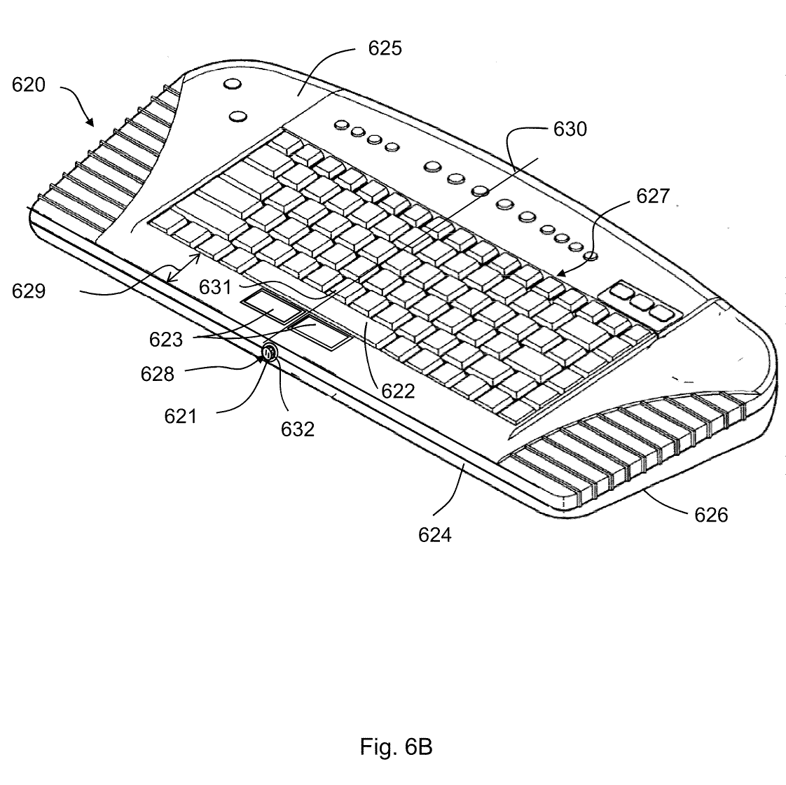

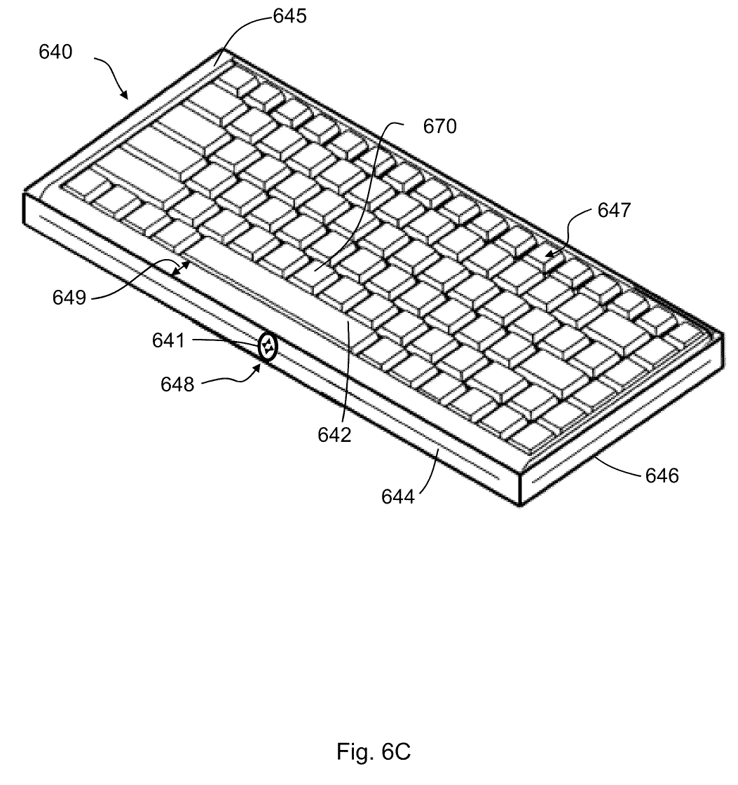

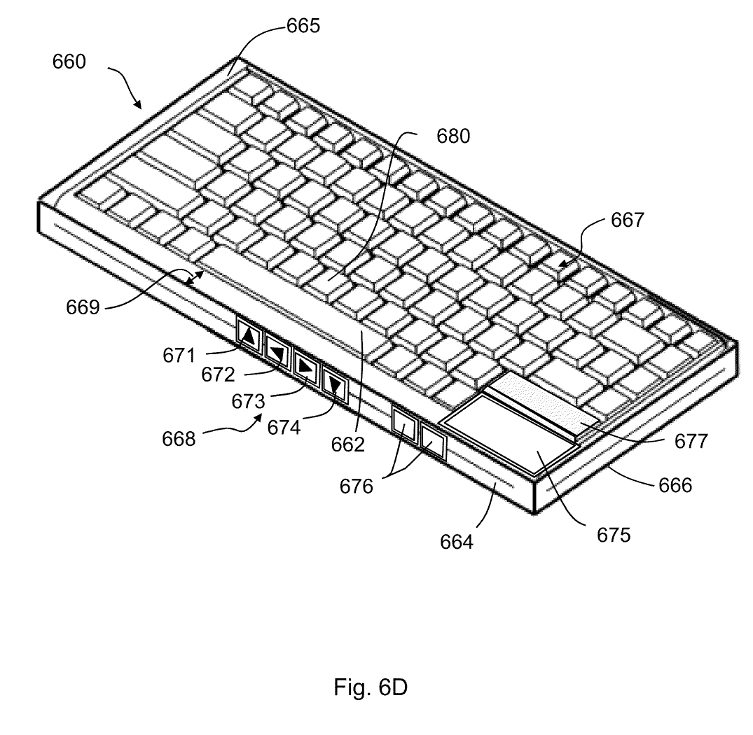

FIG. 6A is a perspective view of a keyboard assembly 600, comprising a keyboard housing 606 having a top side 605 in which an alphanumeric keyboard 607 is situated, and a front side 604 into which a trackball assembly 608 is mounted, a keyboard 607, a trackball assembly 608, a first set of mouse buttons 603-1, and a second set of mouse buttons 603-2. The trackball assembly 608 is roughly centered under (y) the keyboard 607 from a touch typists perspective (if keyboard 607 is a QWERTY keyboard, the trackball 601 is aligned (y) with the B key) in the front side 604 with the first set of mouse buttons 603-1, comprising a left and a right mouse button, aligned horizontally (x) to the left of the trackball assembly 608, and the second set of mouse buttons 603-2, comprising a left and a right mouse button, aligned horizontally (x) to the right of the trackball assembly 608. Front side 604 is roughly perpendicular to top side 605. Trackball assembly 608 is sized to fit within the Z dimension of the housing 606 at the front side 604, and is mounted such that the trackball 601 extends beyond the outer surface of front side 604 a suitable distance. Some keyboards have sufficient space 609 between the bottom row of keys and the intersection of the top 605 and front 604 sides to fit two or more mouse keys in such space 609 aligned horizontally below the space bar and centered under (y) the B key (standard position for mouse buttons for a trackpoint), while other keyboards have very limited space 609, in which case the mouse buttons are preferably mounted or incorporated into the front side 604. If there is need to use the mouse buttons and the trackball 601 simultaneously, the trackball 601 is operated using the thumb of one hand while the thumb of the other hand operates the mouse buttons 603-1 or -2 closest to it. If the mouse buttons are in the space 609 beneath the space bar, the mouse buttons can be operated with one or more of the fingers while the thumb of the same hand operates the trackball 601. Mouse buttons 603-1 and -2 can be bubble buttons, electro-mechanical buttons, touch- or pressure-sensitive regions of front side 604, or any other type of button appropriate for the purpose, and are mounted such that pressing roughly orthogonal to front side 604 engages them. Trackball assembly 608 can be replaced by trackpoint assembly 628 of keyboard 620 in FIG. 6B.

FIG. 6B is a perspective view of a keyboard assembly 620, comprising a keyboard housing 626 having a top side 625, a front side 624, an alphanumeric keyboard 627 mounted into the top side 625, a stick-type cursor control device (e.g., a trackpoint) assembly 628 mounted into or behind the front side 624 such that the trackpoint stick 621 (or its cap if it has one) extends slightly out from or or is flush with the exterior surface of the front side 624, and a set of mouse buttons 623 horizontally aligned horizontally beneath (y) the space bar 622 and centered on the stick 621. The trackpoint assembly 628 is the roughly centered in the keyboard (if keyboard 627 is a QWERTY keyboard, the trackpoint assembly 628 is aligned (y) the B key 622) in the front side 624. Trackball assembly 628 is of dimensions appropriate to fit within the inner Z dimension of the housing 626 proximate to the front side 624. Mouse buttons 623 can be two mouse buttons as shown in FIG. 6B, or can comprise three or four mouse buttons such as describe elsewhere herein. Mouse buttons 623 can also be mounted in front side 624 as in keyboard 600 in FIG. 6A. The mouse buttons 623 are operated with one or more of the fingers while the thumb of the same hand operates the trackpoint 621. Trackball assembly 608 can replace trackpoint assembly 628. Stick-type cursor control device assembly 628 is mounted within housing 626 with the trackpoint cap and stick 621 extending through an opening 632 in the housing 626. In another embodiment it is mounted to the outside surface of the front side 624, with its electrical connection embedded in the housing 626 or passing through it. In different embodiments, trackpoint assembly 628 operates as a mouse cursor control device, as a four-way navigation device, and operates as both.

FIG. 6C is a perspective view of a keyboard assembly 640 comprising a keyboard housing 646 having a top side 645 and a front side 644, an alphanumeric keyboard 647 situated in the top side 645, and a four-way navigation device 648 mounted roughly centered in the front side 644 (if keyboard 647 is a QWERTY keyboard, the disk 641 is aligned in the y direction with the B key). Four-way navigation device 648 comprises a disk 641 which, like a typical four-way navigation device, the user presses to move the text cursor left, right, up or down. The user presses roughly orthogonal to the front side 644 to operate the device 648. If possible, four-way navigation device 648 is situated above (z) the horizontal centerline of the front side 644 to make it easier for a user to press the bottom (z) quadrant of the disk 641 (that closest to the surface on which the keyboard assembly 640 will rest when in use) to minimize interference by the surface supporting the keyboard, although it can be centered as well. In one embodiment, if a user presses a modifier key while operating the navigation device 648, the navigation device 648 generates signals for commands other than left, right, up and down, such as page up, page down, home and end. The four-way navigation device 648 is positioned to be operated equally easily with the thumb of either hand when the user's hands are in their home touch typing positions, but it can be positioned off center to favor use by one hand of the other, and there can be more than one four-way navigation device mounted into the front side. When installed in the front side of a housing, the four-way navigation device can be shaped other than as a disk. In one embodiment, it has an oblong shape, with the long dimension horizontal and in line with the long dimension of the housing, and the short dimension aligned with the front side's short dimension. An oblong shape will make it easier to operate the navigation device to move left and right (in this example, left and right are at opposite ends of the long dimension of the device). To make it easier to operate the device to move the text cursor up and down, the top and bottom edges in the middle of the oblong where it is narrowest can be raised somewhat. In one embodiment, housing 646 is part of a laptop computer housing.

FIG. 6D is a perspective view of a keyboard assembly 660 comprising a keyboard housing 666 having a top side 665 and a front side 664, an alphanumeric keyboard 667 incorporated into the top side 665, and four navigation keys 668, up 671, left 672, right 673 and down 674, aligned horizontally in that order left to right roughly centered in the front side 664 (if keyboard 667 is a QWERTY keyboard, the navigation keys 668 are aligned in the y direction with what would be the B key 680), although the order of up, down, left and right keys can be in any order. The navigation keys 668 can be any type of key or button or touch-sensitive regions that will perform the function of navigation keys, and can be mounted to be flush with, slightly above or slightly below the outer surface of front side 664 (the outer surface faces the user when the keyboard 667 is in normal use). They are positioned to be operable using the thumb of either hand, with little or no movement of the hand and other fingers from the home row touch typing position if the dimension 669 (from the front side 664 to the bottom row of keys) is short enough. There can be more or less than four keys mounted in the front side 674, and the function of the keys can be other than navigation functions; for example, one of such keys can be a delete key, another a Ctrl key, etc. The navigation keys axis of operation is roughly orthogonal to front side 664; each is operated by pressing the key roughly orthogonal to the front side 664 (i.e., into or toward the front side 664). Any type of key can be used, and the type of key (including the key switch mechanism, the electronics and the key cap, if any) will determine the way the key is mounted on, in or through the front side 664.

Installing navigation keys in the front side of keyboard assembly creates space for a touchpad to be installed in its lower right corner. Keyboard assembly 660 also comprises a touchpad mouse cursor control device 675 located in its lower front right corner under what on a QWERTY keyboard is the left shift key 677. In the front side 664, offset to the left from the touchpad 675 slightly are two mouse buttons 676 for use with the touchpad 675.

It is appropriate to incorporate cursor control and scrolling devices into the front side of a laptop computer for use in cramped places and to increase the ergonomics of operation as there is less stress using the thumb than the hand. Also, some newer clamshell type computers like laptops have wide but short displays and the keyboard takes up most of the keyboard section housing's top side, leaving no room for a touch pad and/or mouse buttons.

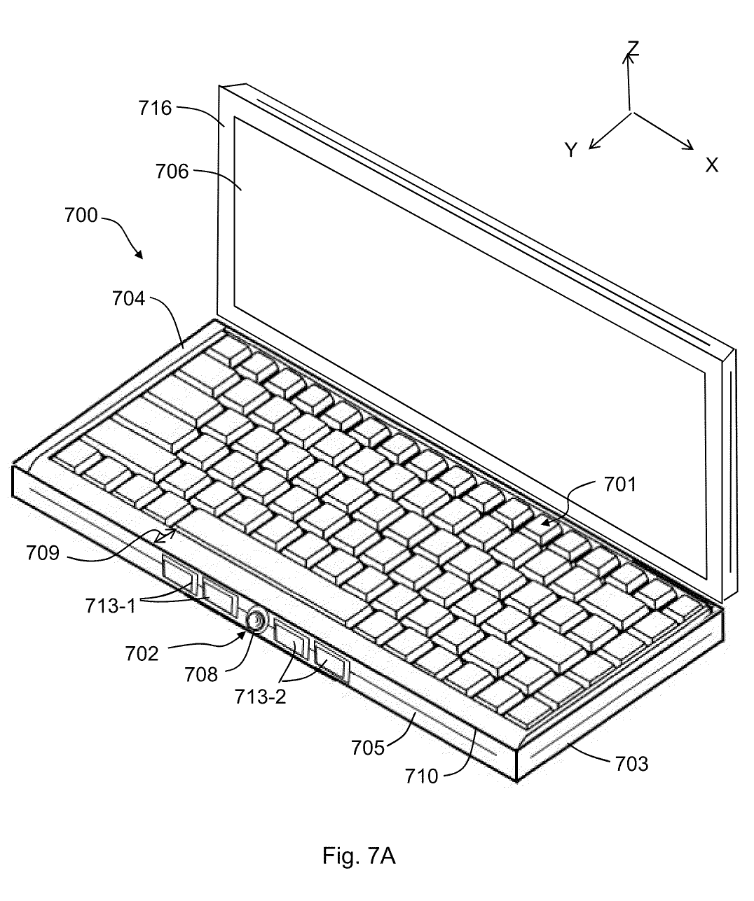

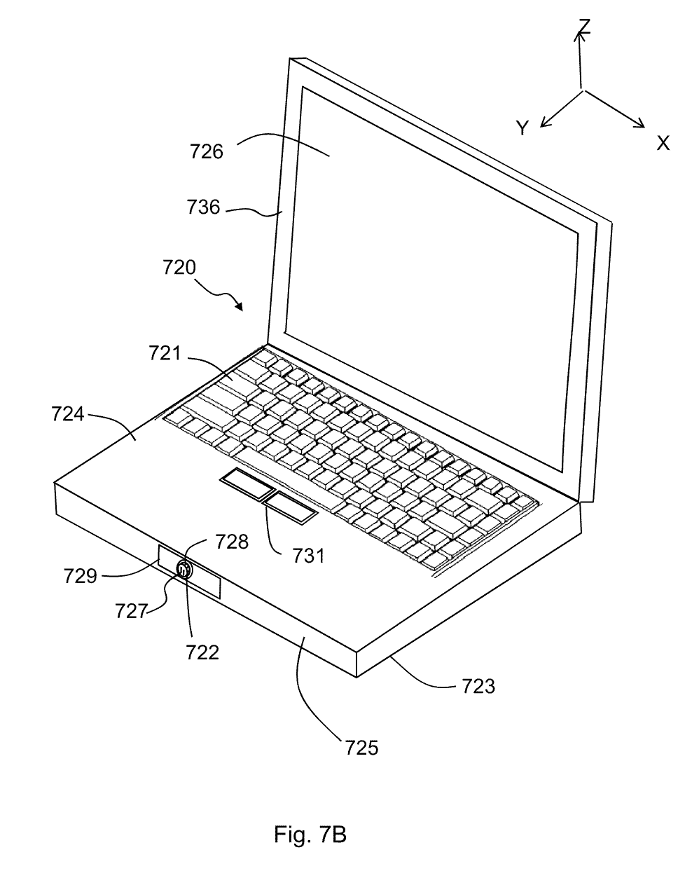

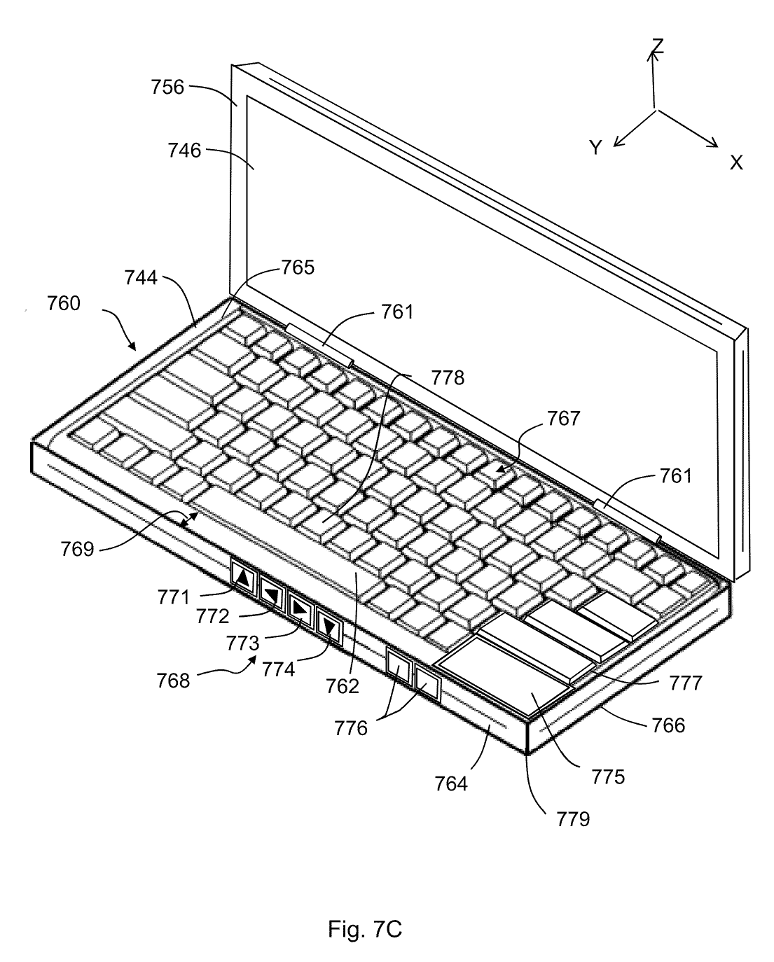

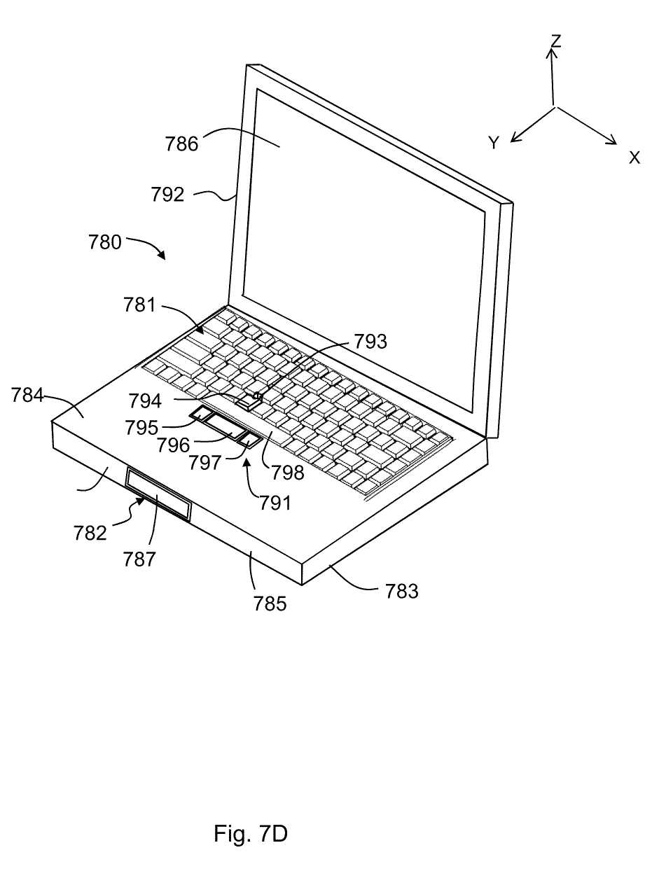

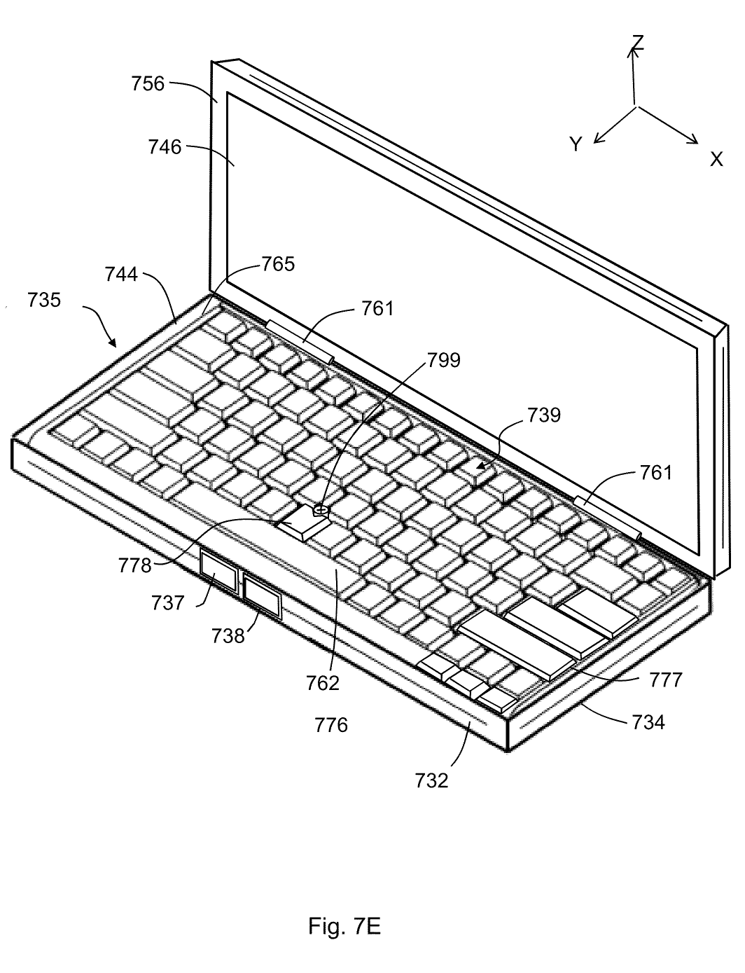

A perspective view of a laptop computer 700 is shown in FIG. 7A. Laptop computer 700 has a form similar to a type of laptop computer referred to by some as a netbook. Laptop computer 700 comprises a display 706 mounted in display section housing 716, an alphanumeric keyboard 701 incorporated into the top side 704 of the keyboard section housing 703, and a ball-type cursor control device 702 comprising a ball 708 and mounted in the front side 705 of the housing 703, which is roughly orthogonal to the top side 704 and faces the user when the laptop 700 is in use. The ball-type cursor control device 702 is part of a ball-type cursor control device assembly, most of which is housed within the keyboard section housing 703. The ball 708 protrudes as much as any similarly sized ball-type cursor control device that is part of another device, such as a trackball or scroll ball. The ball-type cursor control device assembly needs to fit within the Z dimension of the housing 703, and can be mounted to the inside surface of the front side 705, top side 704 or bottom side (not shown and opposite the top side 704) of the keyboard section housing 703, or to another component within the housing. In one embodiment, the ball-type cursor control device 702 is located where it is equally accessible to the thumb of either hand when in normal typing positions, which for a QWERTY keyboard means it is aligned in the y direction with the B key. In one embodiment, ball-type cursor control device 702 is a scroll ball; in one embodiment, it is a track ball. Laptop computer 700 also comprises two sets of mouse buttons, a first set 713-1 to the left of ball 708, and a second set 713-2 to the right of ball 708. If the distance 709 between the front edge 710 and the bottom row of keys is sufficient, mouse buttons can be installed below (y) the bottom row of keys.

A perspective view of a laptop 720 is shown in FIG. 7B. Laptop computer 720 comprises a display 726 incorporated into the display section housing 736, an alphanumeric keyboard 721 incorporated into the top side 724 of the keyboard section housing 723, and a stick -type cursor control device 722 or trackpoint mounted in the front side 725 of the housing 723, which is roughly orthogonal to the top side 724 and faces the user when the laptop 720 is in use. The cap 727 of cursor control device 722 can protrude out from the surface of the front side 725 a slight distance (such as 1/32 or 1/16 inch) or be nearly flush with it. Some trackpoint devices may be low enough profile to be mounted to the outside of the front side 725 with a via for an electrical connection to electronic components within the keyboard section housing 723. Depending upon the stick-type device used as cursor control 722, the sensing part (i.e., that part that senses what the user is doing to the trackpoint stick and generates a signal) may be outside of or within the housing 723. The stick-type cursor control device assembly 722 needs to fit within the Z dimension of the housing 723, and can be mounted to the inside surface of the front side 725 or top side 724 or bottom side (not shown and opposite the top side 724). The device 722 may be mounted to the inside surface of the front side 725, and the stick over which the cap 727 goes protrudes into an opening 728 in the front side 725 enough so that the user contact surface of the cap 727 is slightly out from or flush with the outer surface of the front side 725. The device 722 is preferably located where it is equally accessible to the thumb of either hand when in normal typing positions, which with QWERTY keyboards is generally aligned in the y direction with the B key. Laptop computer 720 also comprises a set of mouse buttons 731 that the user operates in conjunction with trackpoint device 722. The set of mouse buttons 731 comprises two buttons aligned horizontally beneath (y) the space bar centered above (y) the device 722; mouse buttons for the device 722 can be elsewhere such as in the front side 725. In one embodiment, set of mouse buttons 731 comprises four buttons; in another, three buttons. In general, the mouse buttons 731 will be operated with a index or middle finger while the stick-type cursor control device 722 is operated with a thumb of the same hand. In one embodiment, device 722 is configured to operate as a four-way navigation device. In one embodiment, it is configured to operate as a mouse cursor controller. In one embodiment, it is configured to operate in both navigation and mouse mode. In one embodiment, stick-type cursor control device is replaced with mini trackball cursor control device 702.

FIG. 7C is a perspective view of a netbook-style laptop computer 760 comprising display 746 in a display section housing 756 connected by a hinging mechanism 761 to a keyboard section housing 766 having a top side 765 and a front side 764, an alphanumeric keyboard 777 incorporated into the top side 765, and four navigation keys 768, up 771, left 772, right 773 and down 774, aligned horizontally in that order left to right roughly centered in the front side 764 (if keyboard 767 is a QWERTY keyboard, the navigation keys 768 are aligned in the y direction with what would be the B key 778), although the order of up, down, left and right keys can be in any order. The navigation keys 768 can be any type of key or button or touch-sensitive regions that will perform the function of navigation keys, and can be mounted to be flush with, slightly above or slightly below the outer surface of front side 764 (the outer surface faces the user when the keyboard 767 is in normal use). The navigation keys 768 are positioned to be operable using the thumb of either hand, with little or no movement of the hand and other fingers from the home row touch typing position provided the dimension 769 (from the front side 764 to the bottom row of keys) is short enough. There can be more or less than four keys mounted in the front side 774, and the function of the keys can be other than navigation functions; for example, one of such keys can be a delete key, another a backspace key, another a Ctrl key, another a Return key, etc. The navigation keys are operated by pressing roughly orthogonal to the front side 764. Any type of key can be used, and the type of key (including the key switch mechanism, the electronics and the key cap, if any) will determine the way the key is mounted on, in or through the front side 764. The navigation keys 768 can be mounted to the exterior of the housing 766, inset into a recess in the front side 764, part of an assembly, a part of which is seated in an opening in side 764, the other part of which is within the keyboard section housing 766, or in any one of the ways that keys and buttons are mounted in or to the housings of electronic devices. Netbook 760 also comprises a touchpad mouse cursor control device 775 located in its lower front right corner 778 (in the X-Y plane) under what on a QWERTY keyboard is the left shift key 777. In the front side 764, offset to the left from the touchpad 775 slightly are two mouse buttons 776 for use with the touchpad 775. In one embodiment, the four navigation keys 768 are replace by a four-way navigation device such as device 648 shown in FIG. 6C.

A perspective view of a laptop computer 780 is shown in FIG. 7D. Laptop computer 780 comprises a display 786 in display section housing 792, an alphanumeric keyboard 781 incorporated into the top side 784 of the keyboard section housing 783, and a touch-sensitive scroll strip scrolling device 782 mounted in the front side 785 of the keyboard section housing 783, which is roughly orthogonal to the top side 784 and faces the user when the laptop 780 is in use. To scroll, the user strokes a finger horizontally (x) across the touch sensitive surface 787. Only the touch-sensitive scroll strip surface 787 of the scrolling device 782 is open to the outside of the housing 783; the rest of the device is within the keyboard section housing 783. Scroll strip 782 can alternatively be mounted to the outside of the keyboard section housing 783 with wiring passing from the scroll strip assembly into the housing, or in an appropriately shaped depression in the housing 783. The touch-sensitive scroll strip surface 787 is preferably flush with the surface of the front side 785. The touch-sensitive scroll strip assembly 782 needs to fit within the Z dimension of the housing 783. The keyboard housing itself may be rendered touch sensitive in the desired location by positioning appropriate sensors on the inside of the housing directly behind that part of the housing. In one embodiment, the touch-sensitive scroll strip 782 is located where it is equally accessible to the thumb of either hand when in normal typing positions, such as aligned with the B key in the y-direction. It is preferably 1 inch or more in width (x) and ½ or more inches in height (z).

Laptop computer 780 also comprises a stick-type cursor control device 793 of the type described elsewhere herein situated among the keys of the keyboard 781 (if this is a QWERTY keyboard, it is between the G, H and B 794 keys), and three mouse buttons 791, left 795, middle 796 and right 797 aligned below the space bar 798 in that order and centered under (y) the cursor control device 793. The three buttons 795-7 are of equal height (y), and left 795 and right 797 buttons are of equal width, but middle button 796 is approximately twice as wide as the other buttons (buttons 795 and 797 can be about the size of a standard letter key of a full-size keyboard—about 0.75 inches square—or smaller, or slightly larger, in either dimension). Cursor control device 793 can be a four way navigation device, a mouse cursor controller, or it can be a device that can operate to control both the text cursor as a four way navigation device and the mouse cursor. It is intended that one of the smaller button 795 or 797 and the middle button 796 are configured to both operate as one of the left or right mouse button and for the remaining smaller button to operate as the other mouse button.

FIG. 7E is a perspective illustration of a laptop computer 735 similar to laptop computer 760 of FIG. 7C, but without a touchpad in the lower right hand corner of the keyboard or four navigation keys incorporated into the front side of the keyboard section housing. Computer 735 comprises a keyboard 739 with a stick-type cursor control device 799 incorporated among the keys in the center portion of the keyboard (if keyboard 739 is a QWERTY keyboard, key 778 is the B key and device 799 is between the B, G and H keys) and two mouse buttons, left 737 and right 738 incorporated into the front side 732 of keyboard section housing 734, aligned horizontally and centered below (y) the device 799. Mouse buttons 737 and 738 can be operated by the thumb of the same hand operating the cursor control device 799. Cursor control device 799 can be a four way navigation device, a mouse cursor controller, or it can be a device that can operate to control both the text cursor as a four way navigation device and the mouse cursor. In one embodiment, a mini-trackball mouse cursor controller replaces stick-type cursor control device 799. In one embodiment, the two mouse buttons 737 and 738 are replaced by three mouse buttons like buttons 791, and in another embodiment, they are replaced by four mouse buttons like mouse buttons 208. The mouse buttons 737 and 738 are operated by pressing in towards the front side 732, and can be any appropriate type of button or key. They can be mounted on or in the housing 734.

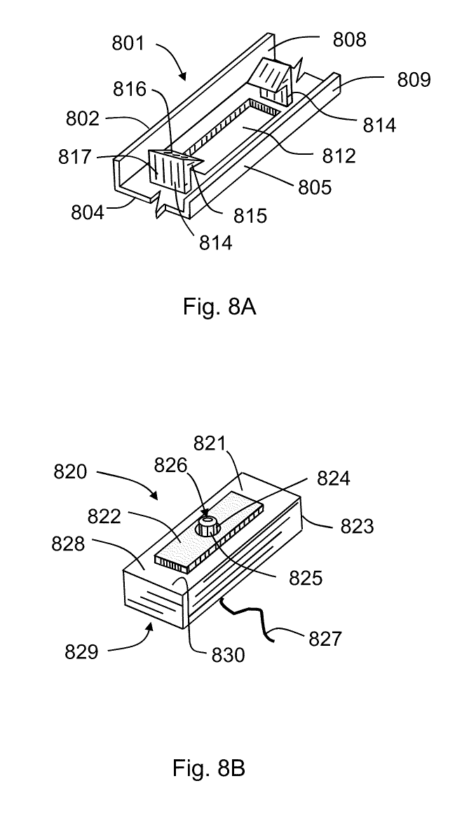

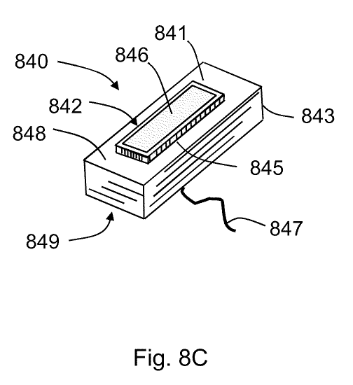

The installation of cursor control and other devices into the front side of the housing of a peripheral keyboard or the keyboard section of a laptop computer can be accomplished in many ways that will be apparent to the designers and manufacturers of such devices. FIG. 8A-E show one way in which these devices can be installed, in particular, an installation design that allows the easy replacement of one type of device with another. FIG. 8A is a perspective view of a cutaway of the front side of the housing 802 of a peripheral keyboard or the keyboard section of a notebook computer comprising an inner side 808, and outer side 809, a top side 805, a front side 804, a rectangular opening 812 which passes through the front side 805, and two clips 814. Clips 814 have a triangular top 815, with an underside (not visible) parallel (or slightly angled) to the front side and an angled topside 816, atop a flexible thinner cross-section element 817 which is mounted to the inner side 808 of the front side 804 so that a notch is created between the triangular elements 815 and the front side 804, and the notches formed by the clips 814 and the front side 804 face each other. When an appropriately sized component is pushed down against the triangular heads 815 of the clips 814, the force against the angled face 816 forces the clips to flex in opposite directions enough to let the component pass, and then the triangular heads 816 will snap back after the component is pushed into the notch and hold it in place.

FIG. 8B is a perspective view of such an appropriately sized component or assembly 820 which comprises a housing 823 incorporating a stick-type cursor control device 826, of which only the cylindrical stick cap or stick 825 is visible (stick/cap 825 protrudes through a cylindrical opening in the top side 830 of raised portion 822; the sensors and other electronics for the device 826 are within the housing 823), and an electrical connection 827 which connects the cursor control device 826 to the keyboard or computer electronics. Housing 823 comprises a main section 821 with a raised portion 822 in a first side 826. Raised portion 822 is a regular right hexahedron which is sized to fit snugly into the opening 812 shown in FIG. 8A and is formed in one side of the main section 821 which is also a regular right hexahedron which is longer, wider and thicker than the raised portion 822. When installed, first side 828 is flush against the inner side of front side 804 with the raised portion 822 seated in opening 812 such that the stick/cap 825 protrudes away from the housing 802, and the flat underside of the triangular head 815 of the clips 814 is snug against the opposite side 829 (side 829 is not visible but is opposite to first side 828). Electrical connector 827 can be of any appropriate type, such as a USB connector, or can consist of pins or contacts which connect assembly 820 to the computer or keyboard electronics when installed into housing 802. The approach just described for installing a stick-type cursor control device in the front side of a housing for a keyboard or clamshell computer could be used to manufacture the laptop computer 720 shown in FIG. 7B, and if it was, the area 729 in the front side 725 of the keyboard section 723 of laptop 720 would be the raised portion 820, and stick/cap 727 would be stick 825/cap.

Assembly 820 can incorporate, instead of a trackpoint device 826, a trackball device, keys of any type, a scroll strip device, a scroll wheel device, or a scroll ball device. In some cases, the size of the slot 812 in the housing 802 may need to be made smaller or larger, with similar changes being made to the raised portion 822 of housing 823, and clips 814 may need to be changed in size and position.

FIG. 8C is an assembly 840 comprising a touch-sensitive scroll strip scrolling device 842 in a housing 843. Raised portion 845 of the housing 843 incorporates a touch-sensitive surface 846 in its top surface, facing away from the housing 843. Assembly 840 is mounted into the housing 802 of a keyboard peripheral, notebook computer, or other device in the same way that assembly 820 was, with the raised portion 845 seated in opening 812 with the touch-sensitive surface 846 on the outside of the housing 802 where it is accessible to a user, surface 848 of the main section 841 of housing 843 in contact with first surface 828 of main section 841 against the inner surface of the front side 804, and clips 814 holding assembly 840 in place. Scroll strip assembly 782 was installed into laptop computer 780 in this manner (scroll strip assembly 782 is assembly 840 and keyboard section housing 783 is housing 802). Assembly 840 is connected electrically to the appropriate device via connector 847 or some other type of connector.

If the slot 812 in the housing 802 is appropriately sized, multiple interchangeable assemblies incorporating different active devices (assemblies 820 and 840 are examples) can be made, and users or the manufacturer can substitute any one for another. Types of devices that are incorporated into various embodiments of this assembly are a trackball, trackpoint, scroll wheel, scroll ball, scroll strip, navigation keys, four-way navigation disk, touchpad, mouse buttons, button or key with equivalent functionality to a keyboard key, joy stick, or other type of device. A USB type connection can be used with any of these devices to interface the active device in the assembly with the computer or other electronics. A laptop computer owner may have two or more different assemblies which he or she swaps in and out of the laptop housing (via a cover plate or door of some sort in the laptop housing) for convenience.

Note that the keyboard shown in the drawings herein are American English QWERTY keyboards. The present invention applies to keyboards from any language. The positions of the devices shown in the drawings herein on non-English, non-QWERTY keyboards can be determined relative to the touch-typing home positions on that keyboard. The keyboards in the drawings are laptop or desktop computer keyboards; however, the present inventions can comprise any type of electronic keyboard, and any embodiment shown on a laptop keyboard can be incorporated into a desktop keyboard, and vice versa. Various types of cursor control devices can be combined in the same keyboard assembly or notebook computer; several examples have been provided.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of” are closed or semi-closed transitional phrases, respectively, with respect to the claims.

The inventions herein are not limited in their application to the details of construction and the arrangement of components set forth in the preceding description or illustrated in the drawings.

The inventions are capable of embodiments and of being practiced or of being carried out in various ways beyond those exemplarily presented herein.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Further, acts, elements, and features discussed only in connection with one embodiment are not intended to be excluded from a similar role in other embodiments.

It is to be appreciated that various alterations, modifications, and improvements can readily occur to those skilled in the art and that such alterations, modifications, and improvements are intended to be part of the disclosure and within the spirit and scope of the invention.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used.

Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed is:

1. An alphanumeric keyboard comprising a four-way navigation device situated at least partially between two letter or number keys.

2. The alphanumeric keyboard of claim 1 wherein the four-way navigation device is at least partially between two keys in the same row touch-typed using different hands.

3. The alphanumeric keyboard of claim 1 wherein the four-way navigation device is a disk four-way navigation device.

4. The alphanumeric keyboard of claim 1 wherein the four-way navigation device comprises a stick-type cursor control device.

5. The alphanumeric keyboard of claim 4 wherein the stick-type cursor control device operates in a first mode as a four-way navigation device and in a second mode as a mouse cursor control device.

6. The alphanumeric keyboard of claim 4 wherein a brief audible signal is produced each time an action on the stick-type cursor control device causes an incremental movement of the text cursor on the display screen.

7. The alphanumeric keyboard of claim 4 further comprising a second stick-type cursor control device situated at least partially between two letter or number keys.

8. The alphanumeric keyboard of claim 7 wherein the two stick-type cursor control devices are positioned symmetrically about the center of the keyboard; and the first stick-type cursor control device is adjacent to the F or G keys; and the second stick-type cursor control device is adjacent to the H and J keys.

9. An alphanumeric keyboard comprising a scrolling device situated at least partially between two letter or number keys.

10. The alphanumeric keyboard of claim 9 further comprising four navigation buttons, left, right, up and down; a touchpad device; and two mouse buttons.

11. The alphanumeric keyboard of claim 10 wherein the keyboard is part of a notebook computer.

12. The alphanumeric keyboard of claim 10 further comprising a housing having a top side in which the keyboard is situated; and a front side substantially perpendicular to the top side; and wherein the two mouse buttons are situated in the front side with their axis of operation roughly perpendicular to the front side.

13. The alphanumeric keyboard of claim 9 wherein the scrolling device is at least partially situated between the G and H keys, the T and Y keys, or the 6 and 7 keys.

14. The alphanumeric keyboard of claim 9 wherein the scrolling device is a scroll wheel, a scroll strip or a scroll ball.

15. The alphanumeric keyboard of claim 9 wherein the key cap of one key adjacent to the scrolling device is smaller in one dimension than other letter or number keys.

16. An alphanumeric keyboard comprising a housing having a top side in which the keyboard is situated; a front side roughly orthogonal to the top side; and a cursor control device or a scrolling device mounted in the front side of the housing.

17. The alphanumeric keyboard of claim 16 wherein the scrolling device is a touch-sensitive scroll strip, a scroll ball or a scroll wheel.

18. The alphanumeric keyboard of claim 16 wherein the cursor control device comprises four navigation keys, a stick-type cursor control device or a trackball.

19. The alphanumeric keyboard of claim 20 wherein the keyboard is incorporated into a notebook computer.

20. The alphanumeric keyboard of claim 20 wherein the cursor control device comprises a plurality of mouse buttons.
